(19) United States
(12) Patent Application Publication
(10) Pub. No.: US 2022/0134756 A1
(43) Pub. Date: May 5, 2022

(54) LIQUID RECEIVING DEVICE AND LIQUID EJECTING APPARATUS

(71) Applicant: SEIKO EPSON CORPORATION, Tokyo (JP)

(72) Inventors: Koji KAWATANI, SHIOJIRI-SHI (JP); Toshio ARIMURA, SHIOJIRI-SHI (JP)

(21) Appl. No.: 17/452,615

(22) Filed: Oct. 28, 2021

(30) Foreign Application Priority Data
Oct. 30, 2020 (JP) 2020-182879

(51) Int. Cl. B41J 2/165; B41J 2/14

(52) U.S. Cl. CPC B41J 2/16505; B41J 2002/16502; B41J 2/1433

(57) ABSTRACT

A liquid receiving device includes a liquid receiving portion configured to receive a liquid ejected from a liquid ejecting portion via an opening portion, a first discharge flow path configured to discharge the liquid in the liquid receiving portion, and a second discharge flow path configured to discharge the liquid in the liquid receiving portion. The liquid receiving portion includes an absorbing member, a first communication portion that has a first discharge port open to an inside of the liquid receiving portion, and a second communication portion that has a second discharge port open to an inside of the liquid receiving portion, the first communication portion is provided at a position where the first discharge port is in contact with the absorbing member, and the second communication portion is provided at a position where the second discharge port is not in contact with the absorbing member.

The present application is based on, and claims priority from JP Application Serial Number 2020-182879, filed Oct. 30, 2020, the disclosure of which is hereby incorporated by reference herein in its entirety.

### BACKGROUND

### 1. Technical Field

The present disclosure relates to a liquid receiving device that receives an ejected liquid and a liquid ejecting apparatus that ejects the liquid to a medium.

### 2. Related Art

A coating apparatus described in JP-A-2011-167655 includes a liquid receiving portion. The liquid receiving portion is provided with a box portion and a porous material. The coating apparatus is an example of a liquid ejecting apparatus, the liquid receiving portion is an example of a liquid receiving device, and the box portion is an example of a liquid receiving portion. In addition, the porous material is an example of an absorbing member that contains the liquid ejected from a nozzle of the coating apparatus. An opening portion is formed on an upper surface of the box portion, and the porous material is disposed in the opening portion. A lower surface of the porous material is in contact with a space below the box portion. The liquid contained by the porous material drops into the space below the box portion and is discharged from a discharge portion communicated with a lower portion of the space.

The amount of liquid contained by the absorbing member of the liquid receiving device changes depending on a usage status of the liquid ejecting apparatus. In a liquid receiving device described in JP-A-2011-167655, when the amount of liquid contained by the absorbing member is large, a speed at which the absorbing member absorbs the liquid and drops the liquid into the space below may not keep up with a speed at which the absorbing member contains the liquid, and the liquid ejected on the absorbing member may be stored on the absorbing member. As a result, the liquid may overflow from the opening portion of the liquid receiving portion. In addition, when the amount of the liquid contained by the absorbing member is small, the liquid absorbed by the absorbing member may dry and thicken or solidify. As a result, the absorption of the contained liquid into the absorbing member is hindered, and a solidified product of the liquid may be accumulated on a containing surface of the absorbing member to contaminate a nozzle surface.

### SUMMARY

According to an aspect of the present disclosure, there is provided a liquid receiving device including a liquid receiving portion configured to receive a liquid ejected from a liquid ejecting portion via an opening portion, a first discharge flow path configured to discharge the liquid of the liquid receiving portion, and a second discharge flow path configured to discharge the liquid of the liquid receiving portion, in which the liquid receiving portion includes an absorbing member provided in the liquid receiving portion and configured to absorb the liquid, a first communication portion that has a first discharge port open to an inside of the liquid receiving portion and communicates with the first discharge flow path, and a second communication portion that has a second discharge port open to an inside of the liquid receiving portion and communicates with the second discharge flow path, the first communication portion is provided at a position where the first discharge port is in contact with the absorbing member, and the second communication portion is provided at a position where the second discharge port is not in contact with the absorbing member.

According to another aspect of the present disclosure, there is provided a liquid ejecting apparatus including a liquid ejecting portion that ejects a liquid, and the above liquid receiving device.

### BRIEF DESCRIPTION OF THE DRAWINGS

FIG. 1 is a perspective view illustrating a liquid ejecting apparatus according to first to third embodiments.

FIG. 2 is a schematic plan view illustrating a maintenance unit of the liquid ejecting apparatus in FIG. 1.

FIG. 3 is a perspective view illustrating a liquid receiving portion included in a liquid receiving device in FIG. 2.

FIG. 4 is a perspective view illustrating a box portion included in the liquid receiving portion in FIG. 3.

FIG. 5 is a perspective view illustrating an absorbing member included in the liquid receiving portion in FIG. 3.

FIG. 6 is a perspective view illustrating a regulating member included in the liquid receiving portion in FIG. 3.

FIG. 7 is a side sectional view of the liquid receiving portion in FIG. 3.

FIG. 8 is a side sectional view of a vicinity of a first communication portion in FIG. 7.

FIG. 9 is a side sectional view of a vicinity of a second communication portion in FIG. 7.

FIG. 10 is a side sectional view of the liquid receiving portion in FIG. 3 when water is supplied into the liquid receiving portion.

FIG. 11 is a perspective view illustrating a drive mechanism included in the liquid receiving device in FIG. 2.

FIG. 12 is a side sectional view illustrating a lifting and lowering mechanism included in the liquid receiving device in FIG. 2.

FIG. 13 is a schematic view illustrating a flow path configuration included in the liquid receiving device according to the first embodiment.

FIG. 14 is a schematic view illustrating a liquid supply portion.

FIG. 15 is a schematic view when the liquid supply portion supplies water in FIG. 14.

FIG. 16 is a schematic view when water is supplied into the liquid receiving portion in FIG. 14.

FIG. 17 is a graph illustrating an example of a weight change of the liquid receiving portion in FIG. 3.

FIG. 18 is a schematic view illustrating a flow path configuration included in a liquid receiving device according to the second embodiment.

FIG. 19 is a schematic view illustrating a flow path configuration included in a liquid receiving device according to the third embodiment.

### DESCRIPTION OF EXEMPLARY EMBODIMENTS

Hereinafter, first to third embodiments of a liquid receiving device and a liquid ejecting apparatus will be described with reference to the drawings. The liquid ejecting apparatus is, for example, an ink jet printer that ejects resin ink, which is an example of a liquid, and a reaction liquid onto a medium such as paper for printing.

In the drawing, a direction of gravity is illustrated by the Z axis, and a direction along a horizontal plane is illustrated by the X axis and the Y axis, assuming that a liquid ejecting apparatus 11 is placed on the horizontal plane. The X axis, Y axis, and Z axis are orthogonal to each other. In the following description, the direction along the X axis is also referred to as a width direction X, the direction along the Y axis is also referred to as a depth direction Y, and the direction along the Z axis is also referred to as a vertical direction Z.

### About Configuration of Liquid Ejecting Apparatus

### First Embodiment

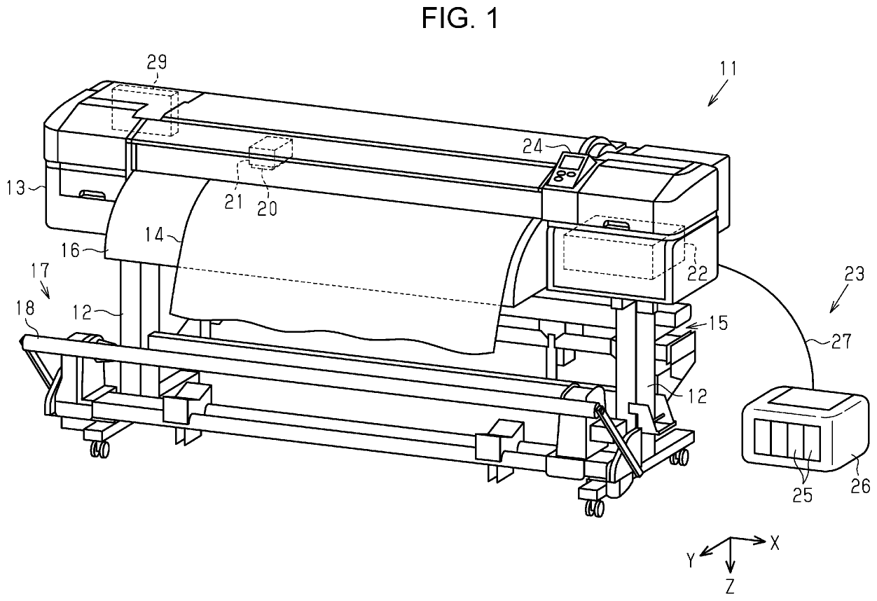

As illustrated in FIG. 1, the liquid ejecting apparatus 11 may be provided with a pair of leg portions 12 and a housing 13 assembled on the leg portions 12. The liquid ejecting apparatus 11 may be provided with a feeding portion 15 that unwinds and feeds a medium 14 wound in a roll shape, a guide portion 16 that guides the medium 14 discharged from the housing 13, and a collection portion 17 that winds and collects the medium 14. The liquid ejecting apparatus 11 may be provided with a tension applying mechanism 18 that applies tension to the medium 14 collected by the collection portion 17.

The liquid ejecting apparatus 11 is provided with a liquid ejecting portion 20 capable of ejecting a liquid, a carriage 21 for moving the liquid ejecting portion 20, and a maintenance unit 22 for maintaining the liquid ejecting portion 20. The liquid ejecting apparatus 11 is provided with a liquid supply device 23 that supplies liquid to the liquid ejecting portion 20, and an operation panel 24 that is operated by the user. The carriage 21 reciprocates the liquid ejecting portion 20 along the X axis. While moving, the liquid ejecting portion 20 ejects the liquid supplied through the liquid supply device 23 and prints the liquid on the medium 14.

The liquid supply device 23 is provided with a mounting portion 26 on which a plurality of liquid containers 25 for containing the liquid are detachably mounted, and a liquid supply flow path 27 that supplies liquid from the liquid container 25 to be mounted on the mounting portion 26 to the liquid ejecting portion 20.

The liquid ejecting apparatus 11 is provided with a control portion 29 that controls the operation of the liquid ejecting apparatus 11. The control portion 29 includes, for example, a CPU, a memory, and the like. The control portion 29 controls the components of the liquid ejecting apparatus 11 such as the liquid ejecting portion 20, the liquid supply device 23, and the maintenance unit 22 by executing the program stored in the memory by the CPU.

### About Configuration of Maintenance Unit

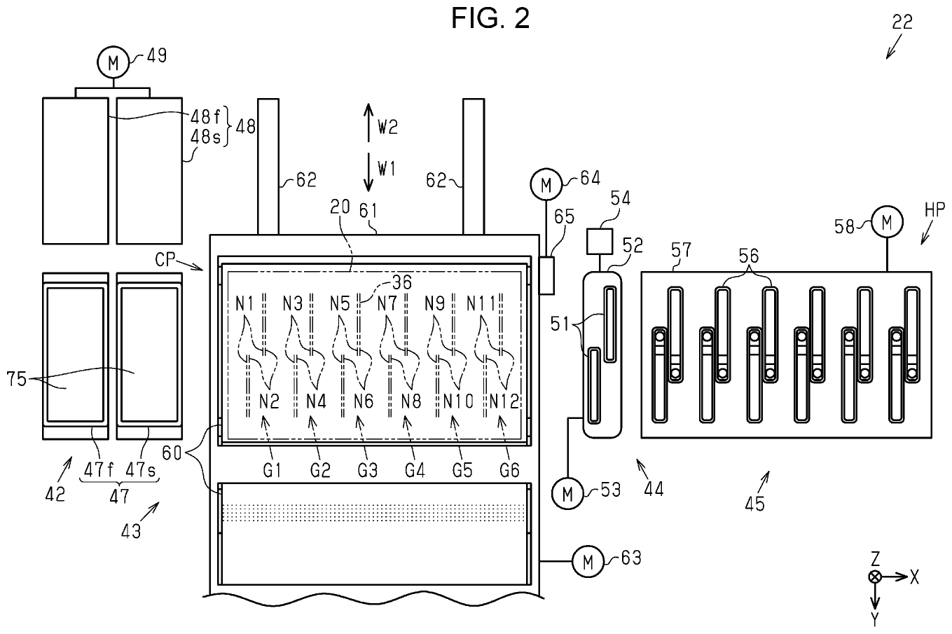

As illustrated in FIG. 2, the maintenance unit 22 includes a liquid receiving device 42, a liquid collection device 43, a suction device 44, and a capping device 45 arranged in the width direction X. Above the capping device 45 is a home position HP of the liquid ejecting portion 20. The home position HP serves as a reference position for movement of the liquid ejecting portion 20. Above the liquid collection device 43 is a cleaning position CP of the liquid ejecting portion 20. In FIG. 2, the liquid ejecting portion 20 located at the cleaning position CP is illustrated by a two-dot chain line.

In the liquid ejecting portion 20, a large number of openings of nozzles 36 for ejecting liquid are arranged in one direction at regular intervals. A plurality of nozzles 36 form a nozzle row. The openings of the nozzles 36 are arranged in the depth direction Y to form a first nozzle row N1 to a twelfth nozzle row N12. The nozzles 36 forming one nozzle row eject the same type of liquid. Of the nozzles 36 constituting one nozzle row, the nozzle 36 located at the rear in the depth direction Y and the nozzle 36 located at the front in the depth direction Y are formed so as to be displaced in the width direction X.

The first nozzle row N1 to the twelfth nozzle row N12 are arranged in two rows close to each other in the width direction X. Two nozzle rows that are arranged close to each other are referred to as a nozzle group. In the liquid ejecting portion 20, a first nozzle group G1 to a sixth nozzle group G6 are disposed at regular intervals in the width direction X.

The first nozzle group G1 includes a first nozzle row N1 for ejecting magenta ink and a second nozzle row N2 for ejecting yellow ink. The second nozzle group G2 includes a third nozzle row N3 for ejecting cyan ink and a fourth nozzle row N4 for ejecting black ink. The third nozzle group G3 includes a fifth nozzle row N5 for ejecting light cyan ink and a sixth nozzle row N6 for ejecting light magenta ink. The fourth nozzle group G4 includes a seventh nozzle row N7 and an eighth nozzle row N8 for ejecting a reaction liquid. The fifth nozzle group G5 includes a ninth nozzle row N9 for ejecting black ink and a tenth nozzle row N10 for ejecting cyan ink. The sixth nozzle group G6 includes an eleventh nozzle row N11 for ejecting yellow ink and a twelfth nozzle row N12 for ejecting magenta ink. Six types of ink, which are magenta ink, yellow ink, cyan ink, black ink, light cyan ink, and light magenta ink, are referred to as resin inks. That is, the liquids ejected from the liquid ejecting portion 20 in the present embodiment are the resin ink and the reaction liquid.

The liquid ejecting portion 20 ejects the reaction liquid to form a reaction liquid layer on the medium 14, and the liquid ejecting portion 20 ejects resin ink onto the reaction liquid layer to form a printed image on the medium 14. Since the reaction liquid contains a coagulant capable of performing aggregation reaction with the coloring material contained in the resin ink, it is possible to prevent a drying time from being prolonged after printing. The liquid ejecting portion 20 may eject the resin ink onto the medium 14 to form a printed image, and then eject the reaction liquid.

The liquid receiving device 42 receives the liquid ejected from the liquid ejecting portion 20 by flushing in the opening portion 75 of the liquid receiving portion 47. That is, the liquid receiving device 42 is configured to be able to receive the liquid ejected from the liquid ejecting portion 20 via the opening portion 75 of the liquid receiving portion 47. Flushing is maintenance in which a liquid is ejected as waste liquid for the purpose of preventing and eliminating clogging of the nozzle 36.

The liquid receiving device 42 is provided with two liquid receiving portions 47 for receiving the liquid ejected by the liquid ejecting portion 20 by flushing, two covers 48 for covering the opening portion 75 of the liquid receiving portion 47, and two cover motors 49 for moving two covers 48. The liquid receiving portion 47 is configured to include a first liquid receiving portion 47f and a second liquid receiving portion 47s. The first liquid receiving portion 47f receives a first liquid Lf, and the second liquid receiving portion 47s receives a second liquid Ls. The cover 48 is configured to include a first cover 48f and a second cover 48s. The first cover 48f is configured to cover the opening portion 75 of the first liquid receiving portion 47f, and the second cover 48s is configured to cover the opening portion 75 of the second liquid receiving portion 47s.

In the present embodiment, when the resin ink and the reaction liquid are received by the same liquid receiving portion 47, the resin ink and the reaction liquid solidify by an aggregation reaction, so that the control portion 29 selects the liquid receiving portion 47 according to the type of liquid. The first liquid Lf is six types of resin inks, and the second liquid Ls is a reaction liquid. That is, the first liquid receiving portion 47f receives the resin ink ejected from the liquid ejecting portion 20 by flushing, and the second liquid receiving portion 47s receives the reaction liquid ejected from the liquid ejecting portion 20 by flushing. The number of types of resin inks is not limited. There may be four types, or only one type. In addition, the number of types of reaction liquids is not limited. As in the present embodiment, one type may be used, or a plurality of types of reaction liquids suitable for the resin ink used may be used.

In the liquid ejecting apparatus 11 in which a plurality of liquids are used, in order to reuse or dispose of the components contained in a certain liquid, only the certain liquid may be contained by a different liquid receiving portion 47 and collected in a place other than the place where the other liquids are collected. Even in such a case, the control portion 29 selects the liquid receiving portion 47 according to the type of liquid. That is, the first liquid receiving portion 47f receives the first liquid Lf collected in another place, and the second liquid receiving portion 47s receives the second liquid Ls which is another liquid.

The two covers 48 are configured to be able to move simultaneously between an open position illustrated in FIG. 2 and exposing the opening portion 75 of the liquid receiving portion 47 and a closed position (not illustrated) covering the opening portion 75 of the liquid receiving portion 47 by driving the cover motor 49. When flushing is not performed, the two covers 48 move to the closed position to suppress the drying of the liquid received in the two liquid receiving portions 47 or the water contained therein. In this manner, the details of the drive mechanism for opening/closing the two covers 48 by driving the cover motor 49 will be described later.

The suction device 44 is provided with a suction cap 51, a suction holding body 52, a suction motor 53 that reciprocates the suction holding body 52 along the Z axis, and a decompression mechanism 54 that reduces the pressure inside the suction cap 51. The suction motor 53 moves the suction cap 51 between a contact position and a retracted position. The contact position is a position where the suction cap 51 comes into contact with the liquid ejecting portion 20 and surrounds the nozzle 36. The retracted position is a position where the suction cap 51 is separated from the liquid ejecting portion 20. The suction cap 51 may be configured to surround all the nozzles 36 together, may be configured to surround at least one nozzle group, or may be configured to surround a part of the nozzles 36 of the nozzles 36 constituting the nozzle group. The suction device 44 according to the present embodiment surrounds one nozzle group of the first nozzle group G1 to the sixth nozzle group G6 by two suction caps 51.

The liquid ejecting apparatus 11 may position the liquid ejecting portion 20 above the suction device 44, position the suction cap 51 at the contact position to surround one nozzle group, and perform suction cleaning that reduces the pressure the inside of the suction cap 51 and discharges the liquid from the nozzle 36. That is, the suction device 44 may contain the liquid discharged by suction cleaning.

The capping device 45 includes a standby cap 56, a leaving holding body 57, and a leaving motor 58 that reciprocates the leaving holding body 57 along the Z axis. By driving the leaving motor 58, the leaving holding body 57 and the standby cap 56 move upward or downward. The standby cap 56 moves from a separation position, which is the lower position, to a capping position, which is the upper position, and comes into contact with the liquid ejecting portion 20 stopped at the home position HP.

The standby cap 56 located at the capping position surrounds the openings of the nozzles 36 constituting the first nozzle group G1 to the sixth nozzle group G6. In this manner, the maintenance in which the standby cap 56 surrounds the opening of the nozzle 36 is referred to as a standby capping. Standby capping is a type of capping. The standby capping suppresses the drying of the nozzle 36.

The standby cap 56 may be configured to surround all the nozzles 36 together, may be configured to surround at least one nozzle group, or may be configured to surround a part of the nozzles 36 of the nozzles 36 constituting the nozzle group.

The liquid collection device 43 is provided with a strip-shaped member 60 capable of absorbing the liquid. The liquid collection device 43 may be provided with a case 61 for containing the strip-shaped member 60, a pair of rails 62 extending along the Y axis, a wiping motor 63, a winding motor 64, and a power transmission mechanism 65 for transmitting the power of the winding motor 64.

The case 61 reciprocates along the Y axis on the rail 62 by the power of the wiping motor 63. Specifically, the case 61 moves between a standby position (not illustrated) and a receiving position illustrated in FIG. 2. When the wiping motor 63 is driven in the forward rotation, the case 61 located in the standby position moves in the first wiping direction W1 parallel to the Y axis and heads for the receiving position. When the wiping motor 63 is driven in the reverse rotation, the case 61 located at the receiving position moves in the second wiping direction W2 opposite to the first wiping direction W1 and heads for the standby position.

The liquid ejecting apparatus 11 may wipe the liquid ejecting portion 20 in at least one process of a process in which the case 61 moves from the standby position to the receiving position and a process in which the case 61 moves from the receiving position to the standby position. Wiping is maintenance in which the nozzle surface of the liquid ejecting portion 20 is wiped with the strip-shaped member 60.

### About Composition of Liquid Receiving Portion

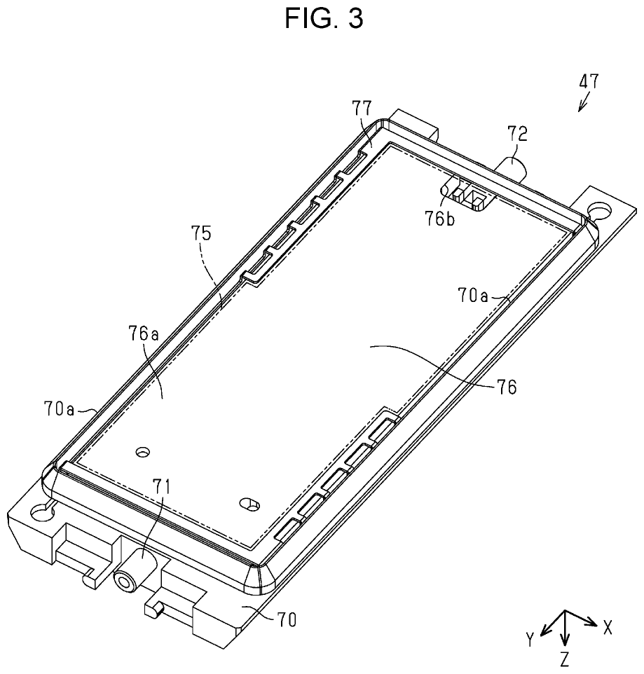

As illustrated in FIG. 3, the liquid receiving portion 47 exhibits a substantially rectangular parallelepiped shape having a low height. The liquid receiving portion 47 includes a box portion 70, an absorbing member 76, and a regulating member 77. A deformed portion 70a is formed in a frame shape on the substantially rectangular upper surface of the box portion 70. The liquid receiving portion 47 includes the opening portion 75 surrounded by a frame of the deformed portion 70a, and the absorbing member 76 and the regulating member 77 that regulates the position of the absorbing member 76 are disposed in the opening portion 75. The liquid receiving portion 47 has a configuration in which the box portion 70, the absorbing member 76, and the regulating member 77 are stacked in this order from the lower side in the vertical direction Z. The liquid ejected by the liquid ejecting portion 20 by flushing is contained by the opening portion 75 and absorbed by the absorbing member 76 disposed in the opening portion 75.

Since a material used for the deformed portion 70a is a flexible material such as a rubber material or an elastomer, the deformed portion 70a can be elastically deformed. In order to suppress the drying of the liquid received in the liquid receiving portion 47, when the cover 48 illustrated in FIG. 2 is moved to the closed position by the drive mechanism described later, the liquid receiving portion 47 rises and presses the deformed portion 70a against the cover 48. The deformed portion 70a is elastically deformed so that the deformed portion 70a comes into close contact with the cover 48.

When the deformed portion 70a is in close contact with the cover 48, the surface of the deformed portion 70a is subjected to a water-repellent treatment in order to prevent the liquid absorbed in the absorbing member 76 from rising on the inner surface of the opening portion 75 due to the capillary force. For example, the material of the deformed portion 70a may be a water-repellent elastomer material that repels the liquid ejected from the liquid ejecting portion 20.

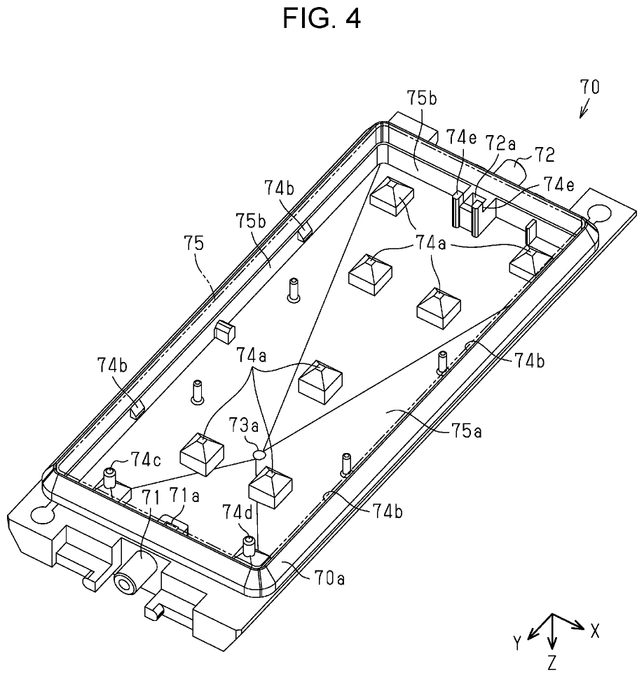

As illustrated in FIG. 4, the box portion 70 includes a first discharge port 71a at the center of one end side in the longitudinal direction of the opening portion 75 and a second discharge port 72a at the center of the other end side of the opening portion 75 in the longitudinal direction. That is, the first discharge port 71a is provided on one end side of the liquid receiving portion 47 in the longitudinal direction, and the second discharge port 72a is provided on the other end side of the liquid receiving portion 47 in the longitudinal direction. In addition, the box portion 70 includes a liquid supply port 73a at substantially the center of a bottom portion 75a in the opening portion 75. The first discharge port 71a, the second discharge port 72a, and the liquid supply port 73a are open to an inside of the liquid receiving portion 47.

The box portion 70 includes a first communication portion 71 at the center of one end side in the longitudinal direction of a substantially rectangular parallelepiped shape, and a second communication portion 72 at the center of the other end side of the substantially rectangular parallelepiped shape in the longitudinal direction. The first communication portion 71 and the second communication portion 72 have tubular shapes in order to couple the flow path for discharging the liquid from the inside of the liquid receiving portion 47. The first communication portion 71 communicates with the first discharge port 71a, and the second communication portion 72 communicates with the second discharge port 72a.

Around the second discharge port 72a, two fence columns 74e as projection portions are provided so as to surround the second discharge port 72a. The fence column 74e as the projection portion is disposed at a position where the fence column 74e engages with the end portion of the absorbing member 76 when the disposed absorbing member 76 moves in the direction of the second discharge port 72a or is displaced so as to increase in volume. As a result, the fence column 74e as the projection portion prevents the absorbing member 76 and the second discharge port 72a from being in contact with each other, and also prevents the second discharge port 72a from being blocked by the absorbing member 76.

In the opening portion 75 of the liquid receiving portion 47, the box portion 70 includes a plurality of seat columns 74a for supporting the absorbing member 76 and positioning engagement portions 74c and 74d on the bottom portion 75a of the opening portion 75. The seat column 74a has a flat surface on the upper surface thereof that supports a lower surface 76e of the absorbing member 76 so that a portion absorbing the liquid does not bend in the vertical direction Z due to the weight of the liquid, when the absorbing member 76 disposed on the opening portion 75 absorbs the liquid. The seat columns 74a are disposed at a plurality of locations on the bottom portion 75a. As a result, the plurality of seat columns 74a regulate the downward movement of the absorbing member 76 in the vertical direction Z.

The positioning engagement portions 74c and 74d engage with the absorbing member 76 to regulate the position of the absorbing member 76 in the XY plane. In addition, the box portion 70 includes two engagement portions 74b on each of the two surfaces in the longitudinal direction constituting an inner portion 75b of the opening portion 75. The engagement portion 74b has a projected shape and engages with the regulating member 77.

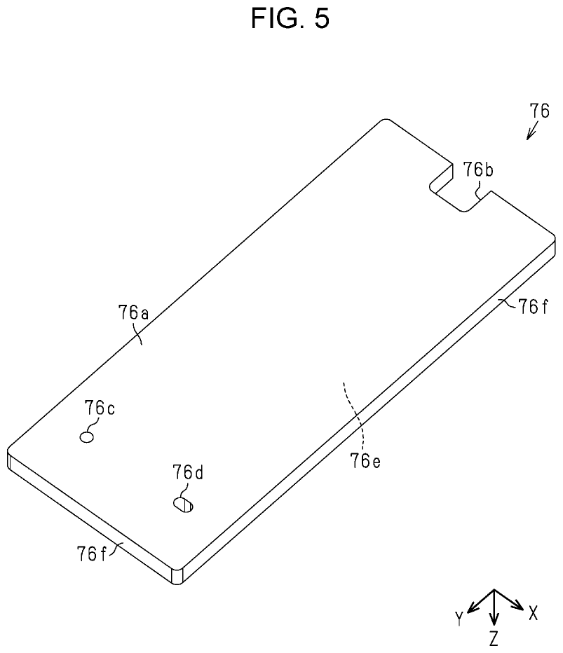

As illustrated in FIG. 5, the absorbing member 76 includes a containing surface 76a as a substantially rectangular upper surface extending in the XY plane, and is formed in a thin plate shape. The containing surface 76a is a surface that contains the liquid in the absorbing member 76. A notch portion 76b is provided in the center of the absorbing member 76 on one end side in the longitudinal direction of the containing surface 76a. In the state of the liquid receiving portion 47 illustrated in FIG. 3, the absorbing member 76 exposes the second discharge port 72a included in the box portion 70 and the two fence column 74e as the projection portions provided around the second discharge port 72a upward from the notch portion 76b. Furthermore, the absorbing member 76 includes the lower surface 76e which is a surface opposite to the containing surface 76a and a plurality of side surfaces 76f which are surfaces forming the periphery of the absorbing member 76.

The absorbing member 76 includes positioning engaged portions 76c and 76d. The positioning engaged portion 76c is engaged with the positioning engagement portion 74c of the box portion 70, and the positioning engaged portion 76d is engaged with the positioning engagement portion 74d of the box portion 70. Accordingly, the position of the absorbing member 76 with respect to the box portion 70 in the XY plane is maintained.

The absorbing member 76 is provided in the liquid receiving portion 47 and is configured to be able to absorb the liquid. Therefore, the absorbing member 76 may be displaced, that is, swelled so as to increase the volume, by absorbing the liquid.

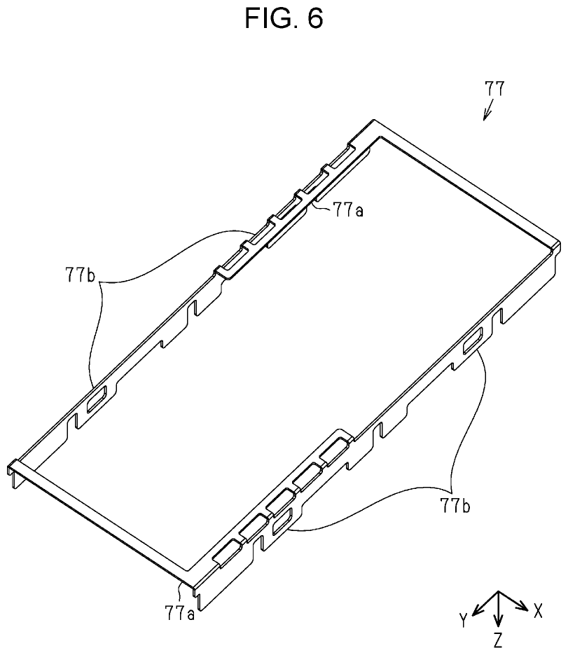

As illustrated in FIG. 6, the regulating member 77 includes a regulating surface 77a for regulating the upward movement of the containing surface 76a included in the absorbing member 76 in the vertical direction Z. The regulating member 77 secures the flatness and strength of the regulating surface 77a by bending the two end portions extending in the longitudinal direction downward on the regulating surface 77a. The material used for the regulating member 77 is, for example, a thin metal plate such as a stainless steel material.

In order to keep the distance between the containing surface 76a and the nozzle surface of the liquid ejecting portion 20 constant while exposing the containing surface 76a of the absorbing member 76 widely, the regulating member 77 regulates the periphery of the containing surface 76a of the absorbing member 76 to a predetermined position on the regulating surface 77a.

The regulating member 77 is provided with two engaged portions 77b at two end portions bent downward and extend in the longitudinal direction. The regulating member 77 is fixed to the box portion 70 by engaging each of the engaged portion 77b with the corresponding engagement portion 74b of the box portion 70.

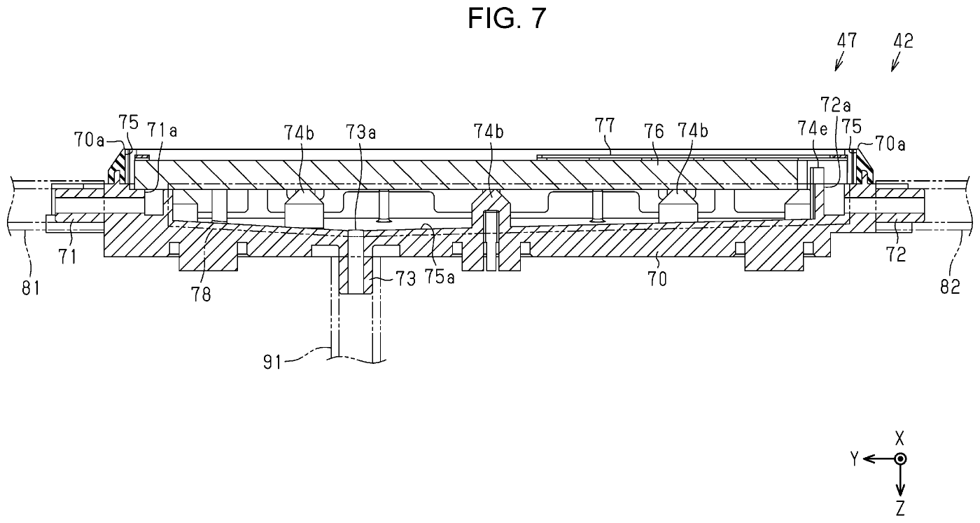

As illustrated in FIG. 7, the liquid receiving portion 47 includes a third communication portion 73 communicating with the inside of the liquid receiving portion 47 through the liquid supply port 73a on the outside of the box portion 70 and at a position corresponding to the liquid supply port 73a. The third communication portion 73 has a tubular shape in order to couple the liquid supply flow path 91 for supplying the liquid containing water into the liquid receiving portion 47. The liquid supply flow path 91 is coupled to the third communication portion 73. For example, the liquid supply flow path 91 is a tube. As a result, the liquid receiving portion 47 and the liquid supply flow path 91 communicate with each other, and the liquid supply flow path 91 is configured to be able to supply a liquid containing water into the liquid receiving portion 47.

The liquid containing water supplied into the liquid receiving portion 47 is a liquid for humidifying the liquid absorbed by the absorbing member 76. In addition, the liquid containing water supplied into the liquid receiving portion 47 is also a liquid for causing the liquid absorbed by the absorbing member 76 to flow out into the liquid containing water when a liquid level comes into contact with the absorbing member 76 and the absorbing member 76 is immersed in the liquid containing water. A liquid containing water is a liquid containing pure water and a small amount of preservative. The resin ink ejected from the liquid ejecting portion 20 may be stored in the first liquid receiving portion 47f instead of the liquid containing water. As a result, the absorbing member 76 absorbs the resin ink stored in the liquid receiving portion 47 or the water evaporating from the resin ink, so that it is possible to humidify the resin ink having a low water content in the absorbing member 76.

As described above, the columnar seat columns 74a disposed at a plurality of locations on the bottom portion 75a support a plurality of locations on the lower surface 76e of the absorbing member 76. As a result, a space 78 is formed between the lower surface 76e of the absorbing member 76 and the bottom portion 75a in the opening portion 75. That is, the liquid receiving portion 47 includes the space 78 below the absorbing member 76. In the liquid receiving portion 47, as the liquid containing water is supplied into the liquid receiving portion 47 from the liquid supply port 73a open to the bottom portion 75a in the opening portion 75, the absorbing member 76 is immersed from the lower surface 76e side.

The liquid receiving device 42 includes a first discharge flow path 81 for discharging the liquid of the liquid receiving portion 47. The first discharge flow path 81 is coupled to the first communication portion 71 having the first discharge port 71a open to the inside of the liquid receiving portion 47. For example, the first discharge flow path 81 is a tube. As a result, the inside of the liquid receiving portion 47 communicates with the first discharge flow path 81, and the first discharge flow path 81 is configured to be able to discharge the liquid in the liquid receiving portion 47.

The liquid receiving device 42 includes a second discharge flow path 82 for discharging the liquid of the liquid receiving portion 47. The second discharge flow path 82 is coupled to the second communication portion 72 having the second discharge port 72a open to the inside of the liquid receiving portion 47. For example, the second discharge flow path 82 is a tube. As a result, the inside of the liquid receiving portion 47 communicates with the second discharge flow path 82, and the second discharge flow path 82 is configured to be able to discharge the liquid in the liquid receiving portion 47.

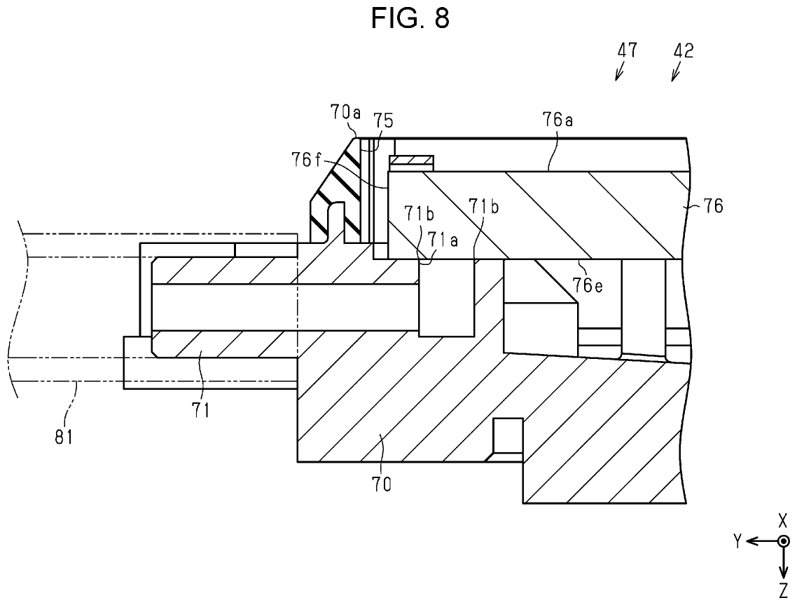

As illustrated in FIG. 8, the first communication portion 71 is provided at a position where the first discharge port 71a is in contact with the absorbing member 76. The contact of the first discharge port 71a with the absorbing member 76 means that the first discharge port 71a is provided at a position where the liquid absorbed by the absorbing member 76 can be sucked from the first discharge port 71a.

In the present embodiment, the first discharge port 71a is provided at a position where the first discharge port 71a is in contact with the lower surface 76e of the absorbing member 76. More specifically, a hole edge portion 71b, which is a portion around the first discharge port 71a in the first communication portion 71, comes into contact with the lower surface 76e of the absorbing member 76. As a result, when the inside of the first communication portion 71 is sucked by a suction pump of a waste liquid collection portion 80 described later, the liquid receiving device 42 is configured so that the liquid absorbed by the absorbing member 76 can be sucked and discharged from the first discharge flow path 81 to the waste liquid collection portion 80 side.

The entire hole edge portion 71b may not be in contact with the absorbing member 76, or a part of the hole edge portion 71b may be in contact with the absorbing member 76. In addition, when the liquid absorbed by the absorbing member 76 is not sucked, the hole edge portion 71b is not in contact with the lower surface 76e of the absorbing member 76, and when the hole edge portion 71b is located significantly close to the lower surface 76e of the absorbing member 76 and the absorbing member 76 is sucked, the case where the absorbing member 76 is attracted to the hole edge portion 71b and the hole edge portion 71b is going to come in contact with the absorbing member 76 is synonymous with the fact that the hole edge portion 71b is in contact with the absorbing member 76. In addition, the outside of the hole edge portion 71b may be in contact with the absorbing member 76. The liquid absorbed by the absorbing member 76 is sucked and the amount of the liquid absorbed by the absorbing member 76 may be reduced.

The first discharge port 71a may be provided at a position in contact with the side surface 76f of the absorbing member 76, or may be provided at a position in contact with the containing surface 76a of the absorbing member 76. That is, the first discharge port 71a may be provided at a position in contact with the surface of the absorbing member 76 other than the lower surface 76e. At this time, the direction where the first discharge port 71a is open may not be upward. That is, the direction where the first discharge port 71a is open may not be the direction where the XY planes are orthogonal to each other. The first discharge port 71a may be provided at a position in contact with the absorbing member 76 in accordance with the surface of the absorbing member 76. In addition, even when the lower surface 76e of the absorbing member 76 is disposed in an inclined state with respect to the XY plane, the first discharge port 71a is provided at a position in contact with the absorbing member 76 in accordance with the lower surface 76e of the absorbing member 76.

Even when the first discharge port 71a is provided at any position, if the first discharge port 71a is provided at a position where the first discharge port 71a is in contact with the absorbing member 76, the liquid receiving device 42 can discharge the liquid absorbed by the absorbing member 76 from the first discharge flow path 81 to the waste liquid collection portion 80 side. Since the liquid absorbed by the absorbing member 76 tends to collect on the lower surface 76e of the absorbing member 76 due to gravity, it is desirable that the first discharge port 71a is provided at a position in contact with the lower surface 76e of the absorbing member 76.

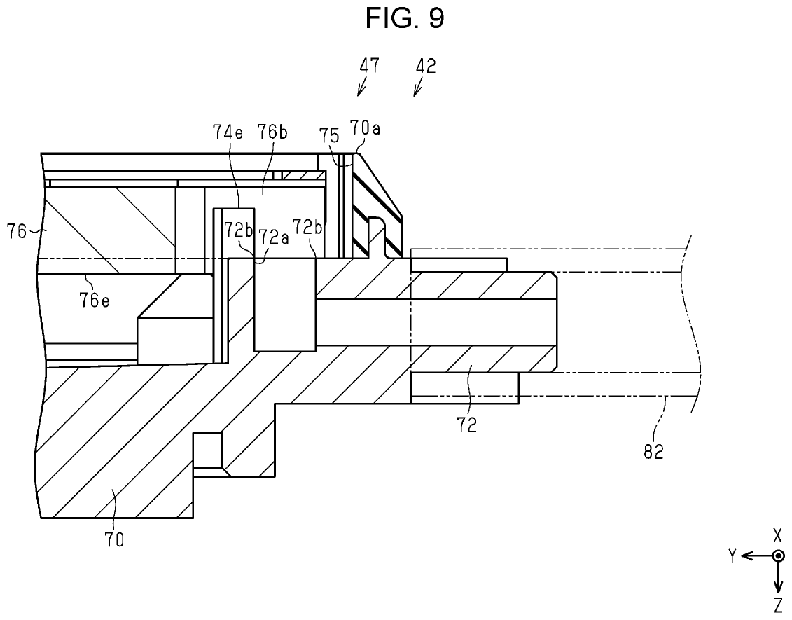

As illustrated in FIG. 9, the second communication portion 72 is provided at a position where the second discharge port 72a does not come into contact with the absorbing member 76. The fact that the second discharge port 72a does not come into contact with the absorbing member 76 means that the second discharge port 72a is provided at a position where the liquid absorbed by the absorbing member 76 cannot be sucked from the second discharge port 72a. The fence column 74e as the projection portion prevents the second discharge port 72a from coming into contact with the absorbing member 76. As a result, when the inside of the second communication portion 72 is sucked by the suction portion 85, it is possible to prevent the liquid absorbed by the absorbing member 76 from being sucked and discharged from the second discharge flow path 82 to the waste liquid collection portion 80 side. In other words, in the liquid receiving device 42, of the liquids in the liquid receiving portion 47, except for the liquid absorbed by the absorbing member 76, the liquids above the second discharge port 72a can be sucked from the second discharge port 72a and discharged from the second discharge flow path 82 to the waste liquid collection portion 80 side. That is, when the inside of the liquid receiving portion 47 is filled with the liquid, the liquid receiving device 42 can discharge the liquid filling the inside of the liquid receiving portion 47 without discharging the liquid absorbed by the absorbing member 76. As a result, the height of the liquid level of the liquid filling the inside of the liquid receiving portion 47 is substantially the same as the height of the second discharge port 72a. More specifically, the height of the liquid level of the liquid filling the inside of the liquid receiving portion 47 is substantially the same as the height of the lower limit of the hole edge portion 72b of the second discharge port 72a.

The direction where the second discharge port 72a is open may be a direction orthogonal to the XY plane or a direction where the XY plane extends. The second discharge port 72a may be opened in a state of being inclined with respect to the XY plane. The second communication portion 72 may be provided at a position where the second discharge port 72a does not come into contact with the absorbing member 76. In the present embodiment, as described above, since the second discharge port 72a is exposed upward from the notch portion 76b of the absorbing member 76, the second discharge port 72a is provided at a position not in contact with the absorbing member 76.

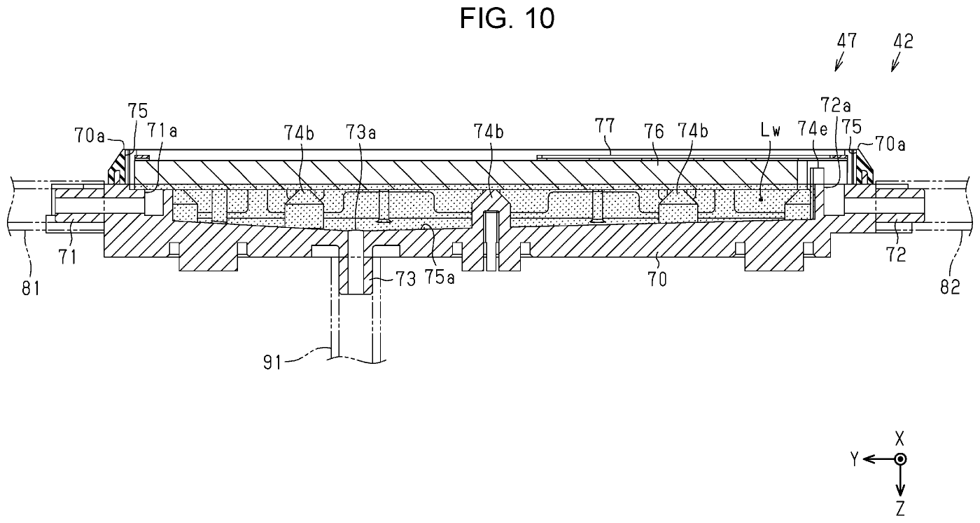

As illustrated in FIG. 10, the absorbing member 76 is provided at a position overlapping the liquid level of the liquid remaining in the liquid receiving portion 47 when the liquid filling the inside of the liquid receiving portion 47 is discharged from the second discharge port 72a. The second discharge port 72a may be provided between the containing surface 76a as the upper surface of the absorbing member 76 and the lower surface 76e in the vertical direction Z. As the liquid Lw containing water is supplied into the liquid receiving portion 47 from the liquid supply port 73a, the inside of the liquid receiving portion 47 is filled with the liquid Lw containing water from the lower side of the space 78, and the absorbing member 76 is immersed in the liquid Lw containing water from the lower surface 76e side. When the absorbing member 76 is sufficiently immersed in the liquid Lw containing water, the supply of the liquid Lw containing water from the liquid supply port 73a is stopped. When the inside of the second communication portion 72 is sucked by the suction portion 85 at the timing when the outflow of the liquid that can flow out into the liquid Lw containing water among the liquid absorbed by the absorbing member 76 is completed, the liquid above the discharge port 72a is sucked from the second discharge port 72a and discharged. The liquid that can flow into the liquid Lw containing water is, for example, a resin ink that is not thickened or a reaction liquid redissolved in water even if the reaction liquid solidifies. For example, the resin ink whose thickening is progressed or solidified cannot flow out into the liquid Lw containing water.

In the present embodiment, when the liquid is discharged from the second discharge port 72a, approximately 20% of the volume of the absorbing member 76 is immersed in the liquid Lw containing water, and the entire surface of the lower surface 76e of the absorbing member 76 is immersed in the liquid Lw containing water. When the liquid is discharged from the second discharge port 72a, the second discharge port 72a is provided at a height at which the absorbing member 76 is in such a state. The absorbing member 76 may be in a state where all of the absorbing member 76 is immersed in the liquid Lw containing water, or may be in a state where a part of the lower surface 76e of the absorbing member 76 is immersed in the liquid Lw containing water. In addition, the absorbing member 76 may have a projection portion on the lower surface 76e, and only the projection portion may be immersed in the liquid Lw containing water. That is, when the absorbing member 76 is immersed in the liquid Lw containing water even a little, the absorbing member 76 continuously absorbs the liquid Lw containing water from the portion immersed in the liquid Lw containing water. In addition, the liquid in the absorbing member 76 continuously flows out from the portion immersed in the liquid Lw containing water into the liquid Lw containing water. In the present embodiment, the first discharge port 71a is provided at a position in contact with the lower surface 76e of the absorbing member 76, and the second discharge port 72a is provided at a position higher than the first discharge port 71a. As a result, when the liquid is discharged from the second discharge port 72a, the lower surface 76e of the absorbing member 76 is immersed in the liquid Lw containing water.

When the liquid is discharged from the second discharge port 72a, the absorbing member 76 may not be immersed in the liquid Lw containing water at all, and the liquid Lw containing water may remain in the space 78. When the liquid Lw containing water even a little remains in the space 78, the absorbing member 76 located above the space 78 is continuously humidified by the water evaporating from the liquid Lw containing water.

### About Drive Mechanism Opening/Closing Cover

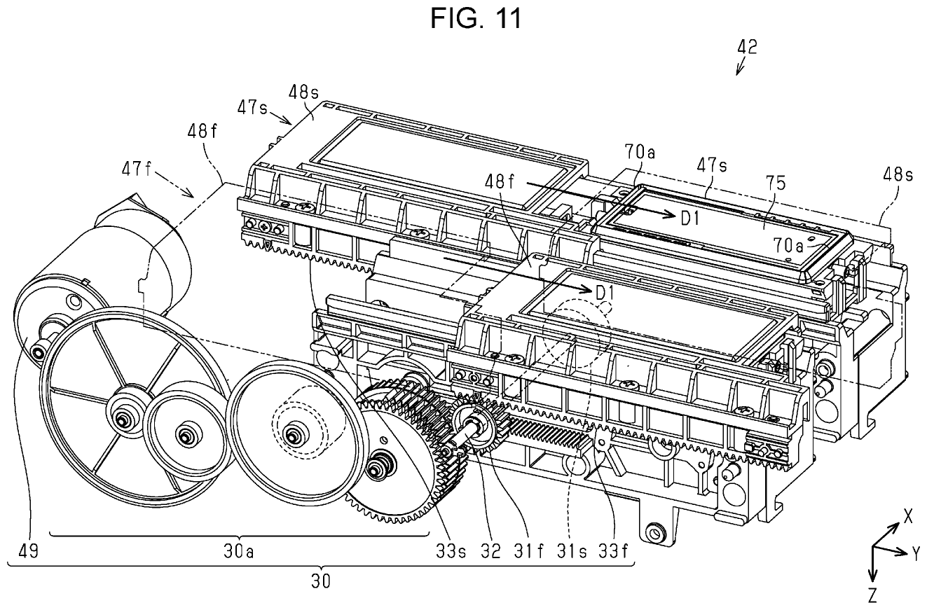

As illustrated in FIG. 11, the liquid receiving device 42 is provided with one drive mechanism 30 capable of simultaneously moving the first cover 48f and the second cover 48s. The drive mechanism 30 in the present embodiment is a rack and pinion mechanism. The drive mechanism 30 is configured to include a cover motor 49, a gear train 30a, two pinion gears 31f and 31s, a pinion shaft 32, and two rack gears 33f and 33s.

The rack gear 33f is integrally molded with the first cover 48f, and the rack gear 33s is integrally molded with the second cover 48s. The rack gears 33f and 33s may each be configured as a single component and may be fixed to the first cover 48f and the second cover 48s, respectively.

When the rotation shaft of the cover motor 49 rotates, the rotation is decelerated by the gear train 30a, and the pinion gear 31f rotates. Since the two pinion gears 31f and 31s are fixed to the common pinion shaft 32, when one pinion gear 31f rotates, the other pinion gear 31s also rotates synchronously. When the pinion gear 31f rotates, the rack gear 33f that meshes with the pinion gear 31f moves linearly, so that the first cover 48f integrated with the rack gear 33f moves. In addition, when the pinion gear 31s rotates, the rack gear 33s that meshes with the pinion gear 31s moves linearly, so that the second cover 48s integrated with the rack gear 33s moves. As a result, the drive mechanism 30 moves the first cover 48f having the rack gear 33f and the second cover 48s having the rack gear 33s, respectively.

When the first cover 48f of the first liquid receiving portion 47f is located at the open position indicated by a two-dot chain line in FIG. 11 and exposing the opening portion 75, the second cover 48s of the second liquid receiving portion 47s is located at the open position illustrated by a solid line in FIG. 11 and exposing the opening portion 75. When the cover motor 49 starts rotating, the first cover 48f and the second cover 48s simultaneously move in the closing direction D1. When the first cover 48f of the first liquid receiving portion 47f moves to the closed position illustrated by the solid line in FIG. 11 and covering the opening portion 75, the cover motor 49 stops rotating. When one pinion gear 31f rotates, the other pinion gear 31s also rotates synchronously. Therefore, at this time, the second cover 48s of the second liquid receiving portion 47s is also located at the closed position indicated by the two-dot chain line in FIG. 11 and covering the opening portion 75. That is, the liquid receiving device 42 is configured so that two covers 48 can be simultaneously moved between the open position exposing the opening portion 75 of the liquid receiving portion 47 and the closed position covering the opening portion 75 of the liquid receiving portion 47 by one drive mechanism 30.

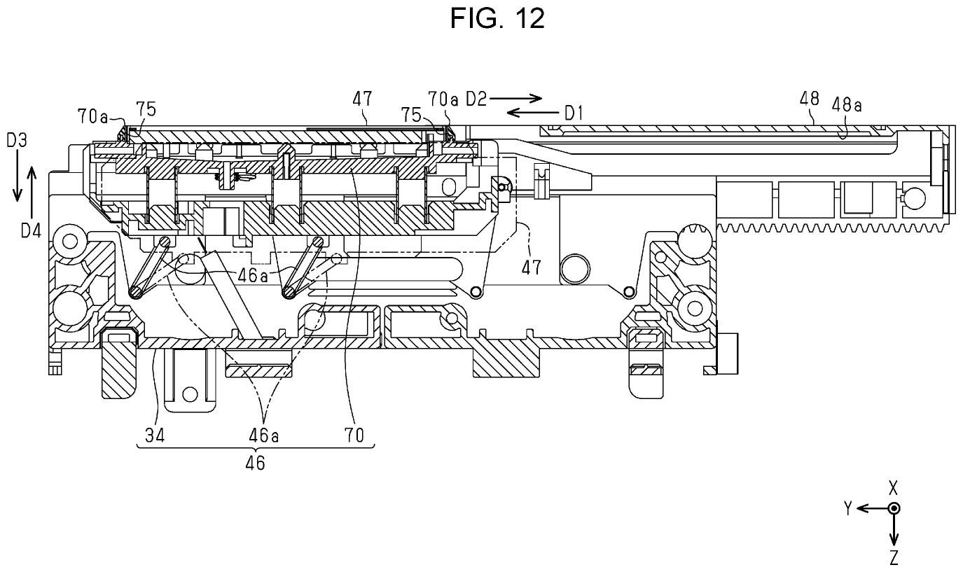

As illustrated in FIG. 12, the liquid receiving device 42 is provided with a lifting and lowering mechanism 46 capable of lifting and lowering the liquid receiving portion 47. The lifting and lowering mechanism 46 in the present embodiment is a parallel link mechanism that constitutes a link into a parallelogram. As a result, the lifting and lowering mechanism 46 translates the liquid receiving portion 47. The lifting and lowering mechanism 46 illustrated in FIG. 12 is interlocked with the operation of the drive mechanism 30 illustrated in FIG. 11.

The liquid receiving device 42 includes a base portion 34 that holds the liquid receiving portion 47 via the two links 46a. In the two links 46a having the same shape constituting the lifting and lowering mechanism 46, one end is pivotally coupled to the base portion 34 and the other end is pivotally coupled to the box portion 70 of the liquid receiving portion 47. The lifting and lowering mechanism 46 is configured so that the two links 46a are parallel to each other. As a result, a parallelogram is formed by the two links 46a, the base portion 34, and the box portion 70, and the box portion 70 is configured to be able to be lifted and lowered with respect to the base portion 34 without changing the inclination of the box portion 70 with respect to the XY plane.

When the cover 48 is located at the open position illustrated in FIG. 12 and exposing the opening portion 75 of the liquid receiving portion 47, the operation of the drive mechanism 30 illustrated in FIG. 11 is started, and the cover 48 moves in the closing direction D1. When the cover 48 pushes down a part of the box portion 70 as the cover 48 moves in the closing direction D1, the lifting and lowering mechanism 46 moves the liquid receiving portion 47 downward and to the right without changing the inclination. That is, the liquid receiving portion 47 translates in the direction between the descending direction D3 and the opening direction D2 from the position of the solid line illustrated in FIG. 12 to the position of a two-dot chain line illustrated in FIG. 12. As a result, the height of the deformed portion 70a formed in a frame shape around the opening portion 75 of the liquid receiving portion 47 is lower than the height of the rear surface 48a of the cover 48, so that the cover 48 can move above the opening portion 75 without coming into contact with the deformed portion 70a.

When the cover 48 moves in the closing direction D1 and reaches above the opening portion 75, as the cover 48 moves in the closing direction D1, the push-down of the box portion 70 by the cover 48 is released, and the lifting and lowering mechanism 46 moves the liquid receiving portion 47 to the upper left without changing the inclination. That is, the liquid receiving portion 47 translates in the direction between the ascending direction D4 and the closing direction D1 from the position of the two-dot chain line illustrated in FIG. 12 to the position of the solid line illustrated in FIG. 12. As a result, the deformed portion 70a formed in a frame shape around the opening portion 75 of the liquid receiving portion 47 is pressed against the rear surface 48a of the cover 48. At this time, the deformed portion 70a is elastically deformed so that the deformed portion 70a and the rear surface 48a of the cover 48 come into close contact with each other. That is, the first liquid receiving portion 47f and the second liquid receiving portion 47s can come in contact with the first cover 48f and the second cover 48s, respectively, and have an elastically deformable deformed portion 70a in a state of surrounding the opening portion 75. As a result, the drying of the liquid received in the liquid receiving portion 47 is suppressed.

For example, the cover 48 includes a plate cam, the box portion 70 includes a follower roller, and the plate cam pushes down the follower roller according to the profile of the plate cam. As a result, the liquid receiving device 42 is configured so that the operation of the cover 48 pushing down a part of the box portion 70 and the operation of releasing the push-down can be interlocked with the operation of the drive mechanism 30.

When the cover 48 is located at the closed position (not illustrated) covering the opening portion 75 of the liquid receiving portion 47, the operation of the drive mechanism 30 illustrated in FIG. 11 is started, and the cover 48 moves in the opening direction D2. When the cover 48 pushes down a part of the box portion 70 as the cover 48 moves in the opening direction D2, the liquid receiving portion 47 translates in the direction between the descending direction D3 and the opening direction D2 by the lifting and lowering mechanism 46. As a result, the liquid receiving portion 47 can be moved in the descending direction D3 while the cover 48 is moving in the opening direction D2.

Furthermore, when the cover 48 moves in the opening direction D2 to expose the opening portion 75, the push-down of the box portion 70 by the cover 48 is released as the cover 48 moves in the opening direction D2. Therefore, the liquid receiving portion 47 translates in the direction between the ascending direction D4 and the closing direction D1 by the lifting and lowering mechanism 46.

### About Waste Liquid Collection Portion

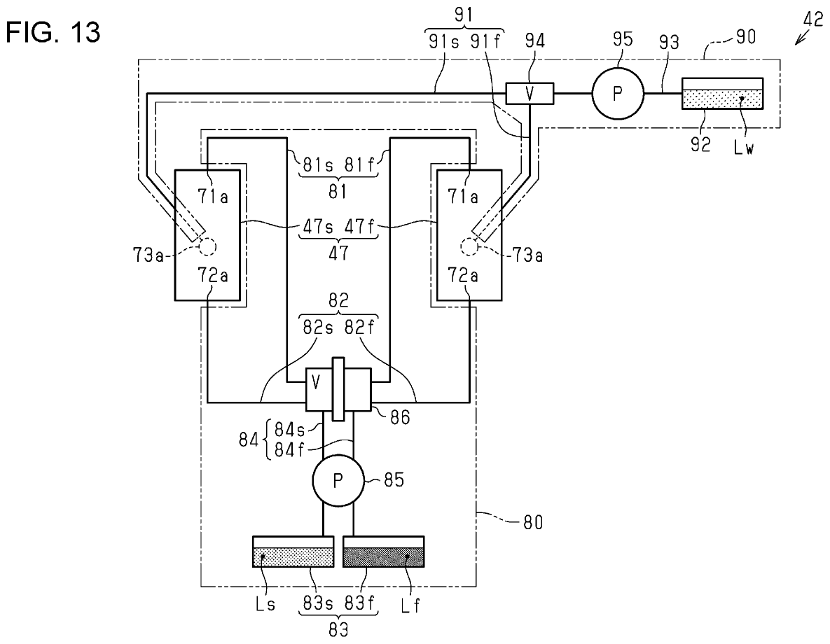

As illustrated in FIG. 13, the liquid receiving device 42 is provided with a liquid supply portion 90 that supplies the liquid Lw containing water to the liquid receiving portion 47, and the waste liquid collection portion 80 that collects the liquid received by the liquid receiving portion 47 via the opening portion 75. In the present embodiment, the liquid receiving device 42 includes the first liquid receiving portion 47f configured to receive the first liquid Lf and the second liquid receiving portion 47s configured to receive the second liquid Ls. The liquid supply portion 90 supplies the liquid Lw containing water to the first liquid receiving portion 47f and the second liquid receiving portion 47s, and the waste liquid collection portion 80 collects the first liquid Lf from the first liquid receiving portion 47f and the second liquid Ls from the second liquid receiving portion 47s.

The waste liquid collection portion 80 is provided with a first discharge flow path 81, a second discharge flow path 82, a waste liquid tank 83, a collection flow path 84, a suction portion 85, and a flow path switching portion 86. The first discharge flow path 81 is configured to include a first discharge flow path 81f and a first discharge flow path 81s, and the second discharge flow path 82 is configured to include a second discharge flow path 82f and a second discharge flow path 82s. The first discharge flow path 81f communicates with the first liquid receiving portion 47f through the first discharge port 71a included in the first liquid receiving portion 47f The first discharge flow path 81s communicates with the second liquid receiving portion 47s through the first discharge port 71a included in the second liquid receiving portion 47s. The second discharge flow path 82f communicates with the first liquid receiving portion 47f through the second discharge port 72a included in the first liquid receiving portion 47f The second discharge flow path 82s communicates with the second liquid receiving portion 47s through the second discharge port 72a included in the second liquid receiving portion 47s.

The waste liquid tank 83 contains the liquid collected from the liquid receiving portion 47. More specifically, the resin ink, which is an example of the first liquid Lf received by the first liquid receiving portion 47f, is received in the waste liquid tank 83f, and the reaction liquid, which is an example of the second liquid Ls received by the second liquid receiving portion 47s, is contained in the waste liquid tank 83f.

The liquid Lw containing water supplied by the liquid supply portion 90 is supplied into the first liquid receiving portion 47f and mixed with the first liquid Lf. The resin ink, which is an example of the first liquid Lf ejected from the liquid ejecting portion 20, contains a liquid Lw containing water. Therefore, the mixed liquid of the resin ink and the liquid Lw containing water is also a resin ink, and the resin ink contained in the waste liquid tank 83f is a resin ink having a low water content or a resin ink containing a large amount of the liquid Lw containing water. That is, the mixed liquid of the first liquid Lf and the liquid Lw containing water is also referred to as the first liquid Lf. When the resin ink in the absorbing member 76 is thickened and cannot flow out into the liquid Lw containing water, the liquid Lw containing water itself may be contained.

The liquid Lw containing water supplied by the liquid supply portion 90 is supplied into the second liquid receiving portion 47s and mixed with the second liquid Ls. The reaction liquid, which is an example of the second liquid Ls ejected from the liquid ejecting portion 20, contains a liquid Lw containing water. Therefore, the mixed liquid of the reaction liquid and the liquid Lw containing water is also a reaction liquid, and the reaction liquid contained in the waste liquid tank 83s is a reaction liquid having a low water content or a reaction liquid in which a small amount of the reaction liquid is dissolved in the liquid Lw containing water, and contains the liquid Lw containing water. That is, the mixed liquid of the second liquid Ls and the liquid Lw containing water is also referred to as the second liquid Ls.

The collection flow path 84 is a flow path for containing the liquid discharged from the liquid receiving portion 47 in the waste liquid tank 83. More specifically, the collection flow path 84f contains the resin ink, which is an example of the first liquid Lf discharged from the first liquid receiving portion 47f, in the waste liquid tank 83f, and the collection flow path 84s contains the reaction liquid, which is an example of the second liquid Ls discharged from the second liquid receiving portion 47s, in the waste liquid tank 83s. Since the first liquid Lf and the second liquid Ls flow from the liquid receiving portion 47 toward the waste liquid tank 83, the liquid receiving portion 47 side is referred to as upstream and the waste liquid tank 83 side is referred to as downstream in the waste liquid collection portion 80.

The suction portion 85 simultaneously sucks the first liquid Lf flowing through the collection flow path 84f and the second liquid Ls flowing through the collection flow path 84s and causes the first liquid Lf and the second liquid Ls to flow downstream. The suction portion 85 is, for example, a tube pump. When the tube pump contains the two tubes, different liquids flowing in the two tubes are simultaneously sucked and flowed.

The flow path switching portion 86 can switch between a state where the first discharge flow path 81f and the first discharge flow path 81s communicate with the suction portion 85 and a state where the second discharge flow path 82f and the second discharge flow path 82s communicate with the suction portion 85.

In the present embodiment, the flow path switching portion 86 is configured to be able to simultaneously block a plurality of coupling flow paths by driving a cam. The flow path switching portion 86 includes four coupling flow paths. A first coupling flow path couples the first discharge flow path 81f and the collection flow path 84f A second coupling flow path couples the second discharge flow path 82f and the collection flow path 84f A third coupling flow path couples the first discharge flow path 81s and the collection flow path 84s. A fourth coupling flow path couples the second discharge flow path 82s and the collection flow path 84s.

In a state where the first discharge flow path 81f communicating with the first liquid receiving portion 47f and the first discharge flow path 81s communicating with the second liquid receiving portion 47s communicate with the suction portion 85, the flow path switching portion 86 simultaneously blocks the second coupling flow path and the fourth coupling flow path. As a result, the first discharge flow path 81f communicates with the collection flow path 84f, and the first discharge flow path 81s communicates with the collection flow path 84s. The suction portion 85 sucks the first liquid Lf from the first discharge flow path 81f to contain the first liquid Lf in the waste liquid tank 83f, and sucks the second liquid Ls from the first discharge flow path 81s to contain the second liquid Ls in the waste liquid tank 83s.

In a state where the second discharge flow path 82f communicating with the first liquid receiving portion 47f and the second discharge flow path 82s communicating with the second liquid receiving portion 47s communicate with the suction portion 85, the flow path switching portion 86 simultaneously blocks the first coupling flow path and the third coupling flow path. As a result, the second discharge flow path 82f communicates with the collection flow path 84f, and the second discharge flow path 82s communicates with the collection flow path 84s. The suction portion 85 sucks the first liquid Lf from the second discharge flow path 82f to contain the first liquid Lf in the waste liquid tank 83f, and sucks the second liquid Ls from the second discharge flow path 82s to contain the second liquid Ls in the waste liquid tank 83s.

The waste liquid collection portion 80 may be provided with a first switching valve and a second switching valve instead of the flow path switching portion 86. The first switching valve communicates the collection flow path 84f with either the first discharge flow path 81f or the second discharge flow path 82f. The second switching valve communicates the collection flow path 84s with either the first discharge flow path 81s or the second discharge flow path 82s. The waste liquid collection portion 80 may be provided with a first suction portion that sucks the collection flow path 84f and a second suction portion that sucks the collection flow path 84s. That is, the waste liquid collection portion 80 may be provided with a suction portion 85, which is a first suction portion that sucks the liquid in the first liquid receiving portion 47f via the first discharge flow path 81f or the second discharge flow path 82f, and a flow path switching portion 86, which is a first switching valve capable of switching the discharge flow path communicating with the suction portion 85, which is the first suction portion, of the first discharge flow path 81f and the second discharge flow path 82f The waste liquid collection portion 80 may be provided with a suction portion 85, which is a second suction portion that sucks the liquid in the second liquid receiving portion 47s via the first discharge flow path 81s or the second discharge flow path 82s, and a flow path switching portion 86, which is a second switching valve capable of switching the discharge flow path communicating with the suction portion 85, which is the second suction portion, of the first discharge flow path 81s and the second discharge flow path 82s.

### About Liquid Supply Portion

As illustrated in FIG. 13, the liquid supply portion 90 includes a liquid supply flow path 91, a liquid tank 92, a liquid delivery flow path 93, a switching valve 94, and a delivery portion 95. The liquid supply flow path 91 is configured to include a liquid supply flow path 91f and a liquid supply flow path 91s. The liquid supply flow path 91f communicates with the first liquid receiving portion 47f through the liquid supply port 73a included in the first liquid receiving portion 47f The liquid supply flow path 91s communicates with the second liquid receiving portion 47s through the liquid supply port 73a included in the second liquid receiving portion 47s.

The liquid tank 92 contains a liquid Lw containing water to be supplied to the liquid receiving portion 47. The liquid Lw containing water stored in the liquid tank 92 is a liquid for replenishing the water evaporated from the resin ink, which is an example of the first liquid Lf absorbed by the absorbing member 76 in the first liquid receiving portion 47f The liquid Lw containing water is an evaporation component of the resin ink, and thickening proceeds, when the evaporation component evaporates from the resin ink. In addition, the liquid Lw containing water stored in the liquid tank 92 is a liquid for redissolving the reaction liquid, which is an example of the second liquid Ls absorbed by the absorbing member 76 in the second liquid receiving portion 47s. The liquid Lw containing water is an evaporation component of the reaction liquid, and solidification proceeds when the evaporation component evaporates from the reaction liquid. As described above, the liquid Lw containing water contains pure water and a small amount of preservative. When the evaporation component of the liquid ejected from the liquid ejecting portion 20 is not water, the liquid tank 92 may contain the liquid containing the evaporation component. The liquid containing the evaporation component may be supplied from the liquid tank 92 to the liquid receiving portion 47.

The liquid delivery flow path 93 is a flow path for sending out the liquid Lw containing water contained in the liquid tank 92 from the liquid tank 92 toward the liquid receiving portion 47. Since the liquid Lw containing water flows from the liquid tank 92 toward the liquid receiving portion 47, the liquid tank 92 side is referred to as upstream and the liquid receiving portion 47 side is referred to as downstream in the liquid supply portion 90.

The switching valve 94 communicates the liquid delivery flow path 93 with either the liquid supply flow path 91f or the liquid supply flow path 91s. That is, the switching valve 94 switches a coupling destination of the liquid delivery flow path 93 by using either the liquid supply flow path 91f or the liquid supply flow path 91s. When the coupling destination of the liquid delivery flow path 93 is the liquid supply flow path 91f, the liquid tank 92 and the first liquid receiving portion 47f communicate with each other. When the coupling destination of the liquid delivery flow path 93 is the liquid supply flow path 91s, the liquid tank 92 and the second liquid receiving portion 47s communicate with each other.

The delivery portion 95 sends out the liquid Lw containing water from the upstream to the downstream through the liquid delivery flow path 93. The delivery portion 95 is, for example, a tube pump. When the delivery portion 95 is driven when the coupling destination of the liquid delivery flow path 93 is the liquid supply flow path 91f, the liquid Lw containing water in the liquid tank 92 is supplied into the first liquid receiving portion 47f In addition, when the delivery portion 95 is driven when the coupling destination of the liquid delivery flow path 93 is the liquid supply flow path 91s, the liquid Lw containing water in the liquid tank 92 is supplied into the second liquid receiving portion 47s.

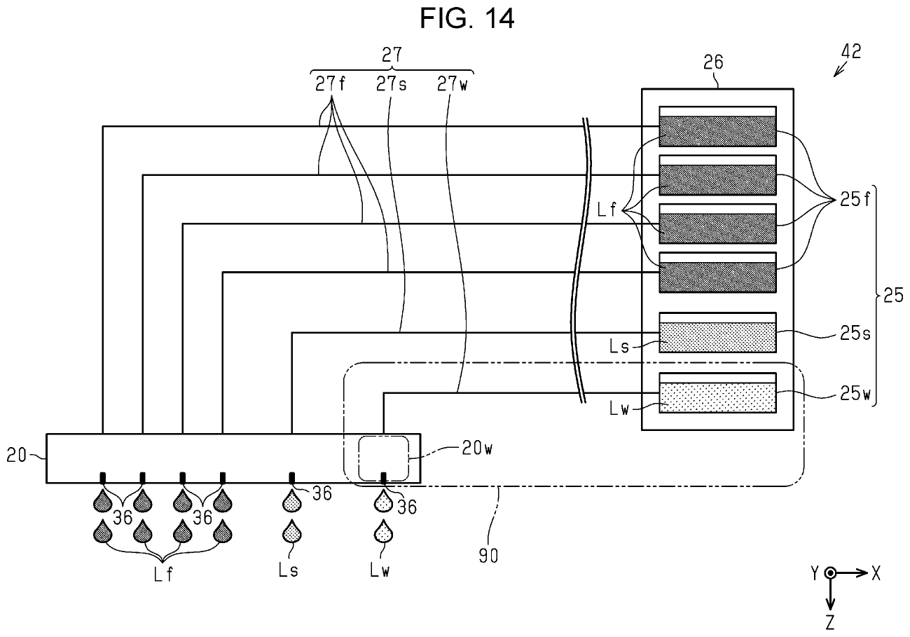

The liquid Lw containing water may be supplied from the liquid ejecting portion 20 into the liquid receiving portion 47 illustrated in FIG. 13. That is, the liquid receiving device 42 may be provided with a liquid supply portion 90 illustrated in FIG. 14 instead of the liquid supply portion 90 illustrated in FIG. 13. At this time, the third communication portion 73 and the liquid supply port 73a illustrated in FIG. 7 may not be provided.

As illustrated in FIG. 14, the liquid ejecting portion 20 is provided with a liquid ejecting portion 20w that ejects the liquid Lw containing water. The liquid supply portion 90 includes a liquid ejecting portion 20w that ejects the liquid Lw containing water, a liquid container 25w that is mounted on the mounting portion 26 and contains the liquid Lw containing water, and a liquid supply flow path 27w that supplies the liquid Lw containing water from the liquid container 25 to the liquid ejecting portion 20. The liquid Lw containing water is configured to include pure water and a small amount of preservative.

A plurality of liquid containers 25f containing the first liquid Lf and the liquid container 25s containing the second liquid Ls are mounted on the mounting portion 26, in addition to the liquid container 25w containing the liquid Lw containing water. The first liquid Lf is supplied from the plurality of liquid containers 25f to the liquid ejecting portion 20 by the liquid supply flow path 27f The second liquid Ls is supplied from the liquid container 25s to the liquid ejecting portion 20 by the liquid supply flow path 27s. As a result, the liquid ejecting portion 20 ejects the first liquid Lf, the second liquid Ls, and the liquid Lw containing water from the nozzle 36.

The first liquid Lf is four types of resin inks, and the second liquid Ls is a reaction liquid. When the liquid ejecting portion 20 ejects the first liquid Lf, the second liquid Ls, and the liquid Lw containing water, the number of types of resin inks is not limited. The number of types of resin inks may be six types or only one type. In addition, the number of types of reaction liquids is not limited. The number of types of reaction liquids may be one type, or a plurality of types of reaction liquids suitable for the resin ink used may be used.

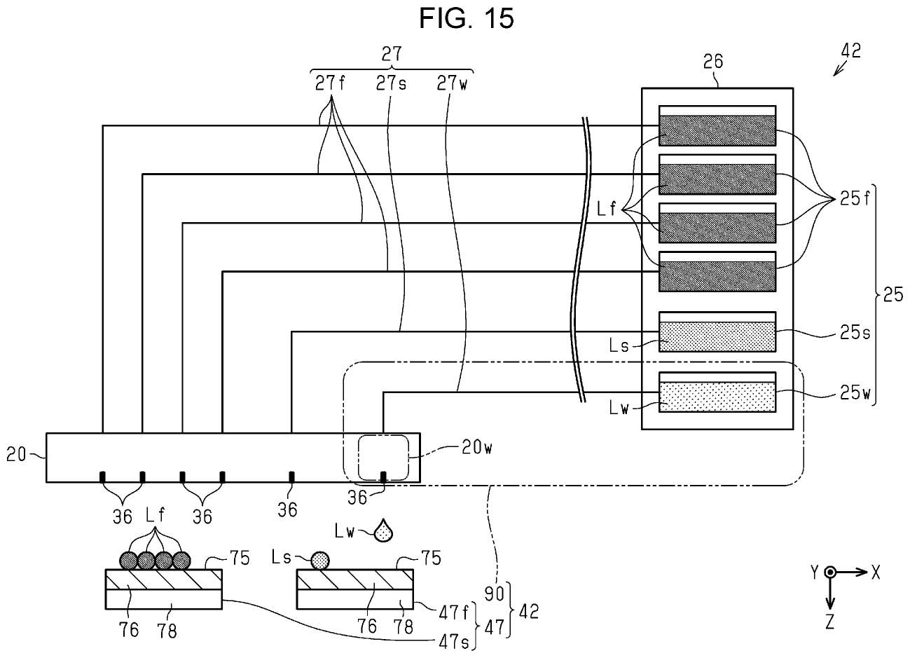

As illustrated in FIG. 15, the liquid receiving device 42 contains the liquid Lw containing water ejected from the liquid ejecting portion 20 by flushing at the opening portion 75 of the liquid receiving portion 47. That is, the liquid receiving device 42 is configured to be able to receive the liquid Lw containing water ejected from the liquid ejecting portion 20 via the opening portion 75. The control portion 29 selects the liquid receiving portion 47 that receives the liquid Lw containing water at the opening portion 75. When the liquid Lw containing water is contained by the opening portion 75 of the first liquid receiving portion 47f, the liquid ejecting portion 20 moves to a position where the position of the nozzle 36 from which the liquid Lw containing water is ejected is above the opening portion 75 of the first liquid receiving portion 47f, and the liquid ejecting portion 20w ejects the liquid Lw containing water. As a result, the first liquid receiving portion 47f that receives the first liquid Lf contains the liquid Lw containing water ejected from the liquid ejecting portion 20 at the opening portion 75 of the first liquid receiving portion 47f When the liquid Lw containing water is contained by the opening portion 75 of the second liquid receiving portion 47s, the liquid ejecting portion 20 moves to a position where the position of the nozzle 36 from which the liquid Lw containing water is ejected is above the opening portion 75 of the second liquid receiving portion 47s, and the liquid ejecting portion 20w ejects the liquid Lw containing water. As a result, the second liquid receiving portion 47s that receives the second liquid Ls contains the liquid Lw containing water ejected from the liquid ejecting portion 20 at the opening portion 75 of the second liquid receiving portion 47s. In this manner, the liquid supply portion 90 supplies the liquid Lw containing water to both the first liquid receiving portion 47f and the second liquid receiving portion 47s.

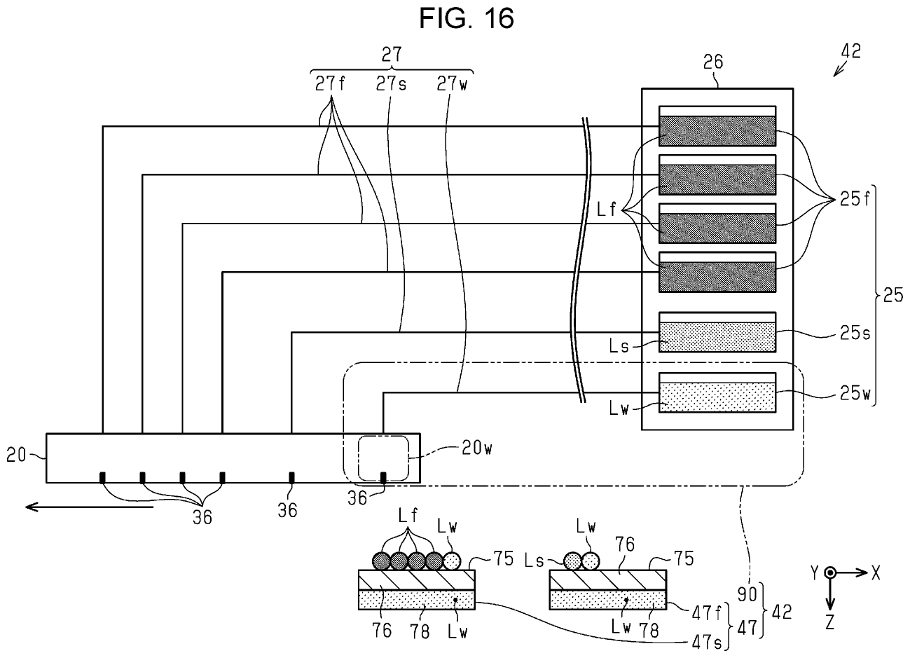

As illustrated in FIG. 16, the liquid Lw containing water contained by the liquid receiving portion 47 is absorbed by the absorbing member 76 located in the opening portion 75. That is, the liquid Lw containing water ejected into the liquid receiving portion 47 is absorbed by the absorbing member 76. In addition, when the liquid Lw containing water in an amount that cannot be absorbed by the absorbing member 76 is ejected into the liquid receiving portion 47 and the liquid Lw containing water is stored in the space 78 below the absorbing member 76, the absorbing member 76 comes into contact with the liquid level of the liquid Lw containing water, and the absorbing member 76 is immersed in the liquid Lw containing water. As a result, the liquid Lw containing water continues to be supplied to the absorbing member 76 so that the first liquid Lf and the second liquid Ls absorbed by the absorbing member 76 do not thicken or solidify, and the liquid absorbed by the absorbing member 76 flows out into the liquid Lw containing water. In addition, the liquid Lw containing water stored in the space 78 below the absorbing member 76 continuously humidifies the first liquid Lf and the second liquid Ls that evaporate water from below and are absorbed by the absorbing member 76, even after the water evaporates and the absorbing member 76 and the liquid level of the liquid Lw containing water do not come into contact with each other.

### About Operation of Liquid Receiving Device

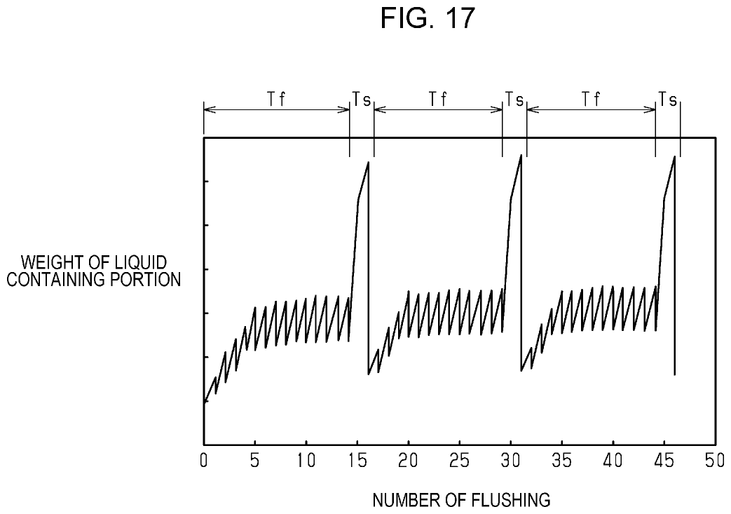

As illustrated in FIG. 17, the liquid receiving device 42 receives the liquid into the opening portion 75, discharges the liquid from the opening portion 75, and supplies the liquid Lw containing water into the opening portion 75. FIG. 17 illustrates an example of a weight change of the liquid receiving portion 47 when the liquid receiving device 42 operates. When the liquid or the liquid Lw containing water is contained or supplied, the weight of the liquid receiving portion 47 increases, and when the liquid or the liquid Lw containing water is discharged, the weight of the liquid receiving portion 47 decreases.

During a period Tf discharged from the first discharge port, after the liquid is contained by the opening portion 75 by flushing, the liquid receiving device 42 sucks the liquid absorbed by the absorbing member 76 at the first discharge port 71a, and the liquid is discharged from the first discharge port 71a. For example, the containing of 1 gram of liquid and the suction of 9000 steps by the suction pump that sucks the first discharge port 71a are repeated a plurality of times. As a result, the liquid receiving device 42 discharges the amount of the liquid corresponding to the amount of the liquid contained in the opening portion 75 by flushing, and prevents the liquid from overflowing from the opening portion 75.

During a period Ts discharged from the second discharge port, after the liquid Lw containing water is supplied from the liquid supply port 73a into the liquid receiving portion 47 including the space 78, the liquid receiving device 42 sucks the liquid in the liquid receiving portion 47 at the second discharge port 72a, and the liquid located above the second discharge port 72a is discharged from the second discharge port 72a. For example, a liquid Lw containing 3 grams of water is supplied, 1 gram of liquid is contained, and the suction of 23000 steps by the suction pump that sucks the second discharge port 72a is performed. As a result, the liquid receiving device 42 immerses the absorbing member 76 in the liquid Lw containing water supplied into the liquid receiving portion 47, causes the liquid absorbed by the absorbing member 76 to flow out into the liquid Lw containing water, and maintains the liquid level height of the supplied liquid Lw containing water at a predetermined height.

In this manner, the operation of the period Tf discharged from the first discharge port and the operation of the period Ts discharged from the second discharge port are repeated, so that the change of state of the liquid absorbed by the absorbing member 76 in the liquid receiving portion 47 is suppressed.

The operation of the present embodiment will be described.

The liquid ejecting apparatus 11 shipped from the factory is installed by the user, and the use of the liquid ejecting apparatus 11 is started. At the time of printing, the liquid ejecting portion 20 first ejects the reaction liquid, which is an example of the second liquid Ls, to form a reaction liquid layer on the medium 14, and the liquid ejecting portion 20 ejects resin ink, which is an example of the first liquid Lf, onto the reaction liquid layer to form a printed image on the medium 14. Since the reaction liquid contains a coagulant capable of performing aggregation reaction with the coloring material contained in the resin ink, it is possible to prevent a drying time from being prolonged after printing.

For the purpose of preventing and eliminating the clogging of the nozzle 36, flushing, which is a maintenance for ejecting the resin ink and the reaction liquid as waste liquid, is periodically performed. In addition, when the nozzle 36 of the liquid ejecting portion 20 is clogged, flushing may be performed a plurality of times by the operation from the operation panel 24 by the user.

When the resin ink is flushed, the drive mechanism 30 moves the first cover 48f to the open position. When the first cover 48f is moved to the open position, the upper portion of the opening portion 75 of the first liquid receiving portion 47f is opened. The resin ink ejected from the liquid ejecting portion 20 by flushing can be contained by the opening portion 75 of the first liquid receiving portion 47f The resin ink can be absorbed by the absorbing member 76 disposed in the opening portion 75 of the first liquid receiving portion 47f.

When the flushing of the resin ink is completed, the drive mechanism 30 moves the first cover 48f to the closed position. When the first cover 48f is moved to the closed position, the upper portion of the opening portion 75 is covered with the first cover 48f The first liquid receiving portion 47f rises in conjunction with the operation in which the upper portion of the opening portion 75 is covered with the first cover 48f, and the deformed portion 70a formed in a frame shape around the opening portion 75 of the first liquid receiving portion 47f is pressed against the rear surface 48a of the first cover 48f. The deformed portion 70a is elastically deformed, so that the adhesion between the first liquid receiving portion 47f and the first cover 48f can be improved, and the drying of the resin ink contained by the first liquid receiving portion 47f in the opening portion 75 can be suppressed. In addition, since the deformed portion 70a whose surface is subjected to the water-repellent treatment is brought into close contact with the first cover 48f, it is possible to prevent the resin ink absorbed in the absorbing member 76 from rising on the inner surface of the opening portion 75 due to the capillary force.

When the reaction liquid is flushed, the drive mechanism 30 moves the second cover 48s to the open position. When the second cover 48s is moved to the open position, the upper portion of the opening portion 75 of the second liquid receiving portion 47s is opened. The reaction liquid ejected from the liquid ejecting portion 20 by flushing can be contained by the opening portion 75 of the second liquid receiving portion 47s. The reaction liquid can be absorbed by the absorbing member 76 disposed in the opening portion 75 of the second liquid receiving portion 47s.

When the flushing of the reaction liquid is completed, the drive mechanism 30 moves the second cover 48s to the closed position. When the second cover 48s is moved to the closed position, the upper portion of the opening portion 75 is covered with the second cover 48s. The second liquid receiving portion 47s rises in conjunction with the operation in which the upper portion of the opening portion 75 is covered with the second cover 48s, and the deformed portion 70a formed in a frame shape around the opening portion 75 of the second liquid receiving portion 47s is pressed against the rear surface 48a of the second cover 48s. The deformed portion 70a is elastically deformed, so that the adhesion between the second liquid receiving portion 47s and the second cover 48s can be improved, and the drying of the reaction liquid received by the second liquid receiving portion 47s in the opening portion 75 can be suppressed. In addition, since the deformed portion 70a whose surface is subjected to the water-repellent treatment is brought into close contact with the second cover 48s, it is possible to prevent the reaction liquid absorbed in the absorbing member 76 from rising on the inner surface of the opening portion 75 due to the capillary force.

The drive mechanism 30 is configured to be able to move simultaneously the first cover 48f and the second cover 48s. Therefore, one drive mechanism 30 can perform the opening operation of the first cover 48f, the closing operation of the first cover 48f, the opening operation of the second cover 48s, and the closing operation of the second cover 48s.

In the first liquid receiving portion 47f, the first discharge port 71a communicating with the first discharge flow path 81f is provided on one end side of the liquid receiving portion 47 in the longitudinal direction, and the second discharge port 72a communicating with the second discharge flow path 82f is provided on the other end side of the liquid receiving portion 47 in the longitudinal direction. In the second liquid receiving portion 47s, the first discharge port 71a communicating with the first discharge flow path 81s is provided on one end side of the first liquid receiving portion 47f in the longitudinal direction, and the second discharge port 72a communicating with the second discharge flow path 82s is provided on the other end side of the second liquid receiving portion 47s in the longitudinal direction. As a result, the first liquid receiving portion 47f and the second liquid receiving portion 47s can be disposed close to each other in the lateral direction, so that the width direction of the liquid receiving device 42 can be reduced.

When the amount of resin ink absorbed by the absorbing member 76 is large, for example, when printing is continuously performed and flushing is performed periodically, the number of flushing from the nozzle 36 for ejecting the resin ink is increased. In addition, when the nozzle 36 for ejecting the resin ink is clogged, the number of flushing from the nozzle 36 for ejecting the resin ink is increased in order to eliminate the clogging. That is, the amount of resin ink absorbed by the absorbing member 76 disposed in the opening portion 75 of the first liquid receiving portion 47f increases. In such a case, the absorbing member 76 in the first liquid receiving portion 47f can no longer absorb the resin ink ejected from the liquid ejecting portion 20, and the resin ink may overflow from the opening portion 75 of the first liquid receiving portion 47f Therefore, it is desirable that the amount of resin ink absorbed by the absorbing member 76 in the first liquid receiving portion 47f is reduced according to the number of flushing of the resin ink.

As illustrated in FIG. 13, when the amount of resin ink absorbed by the absorbing member 76 is large, the flow path switching portion 86 switches to a state where the first discharge flow path 81f communicating with the first liquid receiving portion 47f and the first discharge flow path 81s communicating with the second liquid receiving portion 47s communicate with the suction portion 85. As a result, the first discharge flow path 81f communicating with the first liquid receiving portion 47f can be switched to a state of communicating with the suction portion 85.

The suction portion 85 sucks the resin ink in the first liquid receiving portion 47f via the first discharge flow path 81f and the reaction liquid in the second liquid receiving portion 47s via the first discharge flow path 81s. Since the first discharge flow path 81f communicates with the first communication portion 71 and the first communication portion 71 is provided at a position where the first discharge port 71a is in contact with the absorbing member 76, the resin ink absorbed by the absorbing member 76 in the first liquid receiving portion 47f can be discharged from the first discharge port 71a. As a result, the suction portion 85 can suck the resin ink in the first liquid receiving portion 47f via the first discharge flow path 81f The amount of resin ink absorbed by the absorbing member 76 in the first liquid receiving portion 47f can be reduced. When the number of flushing of the resin ink is increased, the amount of resin ink absorbed by the absorbing member 76 increases, so that this operation is periodically performed according to the number of flushing of the resin ink.

When the amount of reaction liquid absorbed by the absorbing member 76 is large, for example, when printing is continuously performed and flushing is performed periodically, the number of flushing from the nozzle 36 for ejecting the reaction liquid is increased. In addition, when the nozzle 36 for ejecting the reaction liquid is clogged, the number of flushing from the nozzle 36 for ejecting the reaction liquid is increased in order to eliminate the clogging. That is, the amount of the reaction liquid absorbed by the absorbing member 76 disposed in the opening portion 75 of the second liquid receiving portion 47s increases. In such a case, the absorbing member 76 in the second liquid receiving portion 47s can no longer absorb the reaction liquid ejected from the liquid ejecting portion 20, and the reaction liquid may overflow from the opening portion 75 of the second liquid receiving portion 47s. Therefore, it is desirable that the amount of reaction liquid absorbed by the absorbing member 76 in the second liquid receiving portion 47s is reduced according to the number of flushing of the reaction liquid.

As illustrated in FIG. 13, when the amount of reaction liquid absorbed by the absorbing member 76 is large, the flow path switching portion 86 switches to a state where the first discharge flow path 81f communicating with the first liquid receiving portion 47f and the first discharge flow path 81s communicating with the second liquid receiving portion 47s communicate with the suction portion 85. As a result, the first discharge flow path 81s communicating with the second liquid receiving portion 47s can be switched to a state of communicating with the suction portion 85.

The suction portion 85 sucks the resin ink in the first liquid receiving portion 47f via the first discharge flow path 81f and the reaction liquid in the second liquid receiving portion 47s via the first discharge flow path 81s. Since the first discharge flow path 81s communicates with the first communication portion 71 and the first communication portion 71 is provided at a position where the first discharge port 71a is in contact with the absorbing member 76, the reaction liquid absorbed by the absorbing member 76 in the second liquid receiving portion 47s can be discharged from the first discharge port 71a. As a result, the suction portion 85 can suck the reaction liquid in the second liquid receiving portion 47s via the first discharge flow path 81s. The amount of the reaction liquid absorbed by the absorbing member 76 in the second liquid receiving portion 47s can be reduced. When the number of flushing of the reaction liquid is increased, the amount of reaction liquid absorbed by the absorbing member 76 increases, so that this operation is periodically performed according to the number of flushing of the reaction liquid.

The number of flushing from the nozzle 36 that ejects the resin ink and the number of flushing from the nozzle 36 that ejects the reaction liquid may increase. That is, the amount of resin ink absorbed by the absorbing member 76 disposed in the opening portion 75 of the first liquid receiving portion 47f and the amount of the reaction liquid absorbed by the absorbing member 76 disposed in the opening portion 75 of the second liquid receiving portion 47s may increase.

As illustrated in FIG. 13, when the amount of resin ink absorbed by the absorbing member 76 and the amount of reaction liquid absorbed by the absorbing member 76 are large, the flow path switching portion 86 switches to a state where the first discharge flow path 81f communicating with the first liquid receiving portion 47f and the first discharge flow path 81s communicating with the second liquid receiving portion 47s communicate with the suction portion 85. As a result, one suction portion 85 can switch to a state where the first discharge flow path 81f communicating with the first liquid receiving portion 47f and the first discharge flow path 81s communicating with the second liquid receiving portion 47s communicate with the suction portion 85.

The suction portion 85 sucks the resin ink in the first liquid receiving portion 47f via the first discharge flow path 81f and the reaction liquid in the second liquid receiving portion 47s via the first discharge flow path 81s. Since the first discharge flow path 81f communicates with the first communication portion 71 and the first communication portion 71 is provided at a position where the first discharge port 71a is in contact with the absorbing member 76, the resin ink absorbed by the absorbing member 76 in the first liquid receiving portion 47f can be discharged from the first discharge port 71a. As a result, the suction portion 85 can suck the resin ink in the first liquid receiving portion 47f via the first discharge flow path 81f The amount of resin ink absorbed by the absorbing member 76 in the first liquid receiving portion 47f can be reduced. Since the first discharge flow path 81s communicates with the first communication portion 71 and the first communication portion 71 is provided at a position where the first discharge port 71a is in contact with the absorbing member 76, the reaction liquid absorbed by the absorbing member 76 in the second liquid receiving portion 47s can be discharged from the first discharge port 71a. As a result, the suction portion 85 can suck the reaction liquid in the second liquid receiving portion 47s via the first discharge flow path 81s. The amount of the reaction liquid absorbed by the absorbing member 76 in the second liquid receiving portion 47s can be reduced.

When the amount of resin ink absorbed by the absorbing member 76 is small, for example, when the number of flushing of the resin ink is small, the amount of newly supplied resin ink is small, and as time elapses, water evaporates from the resin ink absorbed by the absorbing member 76, so that the resin ink absorbed by the absorbing member 76 gradually thickens. In such a case, the absorbing member 76 cannot absorb the resin ink ejected from the liquid ejecting portion 20 due to clogging, and the absorption of the contained resin ink from the opening portion 75 into the absorbing member 76 is hindered. A solidified product of the resin ink may be accumulated on the containing surface 76a of the absorbing member 76, and the nozzle surface of the liquid ejecting portion 20 may be contaminated. Since the resin ink does not redissolve in the liquid Lw containing water, it is desirable that the liquid Lw containing water is periodically supplied to the resin ink absorbed by the absorbing member 76 so that the absorbing member 76 is not clogged, and thus the thickening of the resin ink is suppressed or the non-thickening resin ink flows out into the liquid Lw containing water.

As illustrated in FIG. 13, when the amount of resin ink absorbed by the absorbing member 76 is small, the flow path switching portion 86 switches to a state where the second discharge flow path 82f communicating with the first liquid receiving portion 47f and the second discharge flow path 82s communicating with the second liquid receiving portion 47s communicate with the suction portion 85. As a result, the second discharge flow path 82f communicating with the first liquid receiving portion 47f can be switched to a state of communicating with the suction portion 85.

The liquid receiving device 42 is provided with a liquid supply portion 90 capable of supplying the liquid Lw containing water in the liquid receiving portion 47 into the first liquid receiving portion 47f More specifically, the switching valve 94 communicates the liquid delivery flow path 93 with the liquid supply flow path 91f, and the delivery portion 95 supplies the liquid Lw containing water in the liquid tank 92 into the first liquid receiving portion 47f As a result, the liquid Lw containing water can be supplied into the first liquid receiving portion 47f.

When the liquid Lw containing water is supplied into the first liquid receiving portion 47f from the liquid supply port 73a, the absorbing member 76 is immersed in the liquid Lw containing water supplied and stored in the first liquid receiving portion 47f In addition, even when the liquid Lw containing water is not supplied until the absorbing member 76 is immersed, the absorbing member 76 can be continuously humidified by the water evaporated from the liquid Lw containing water. As a result, since the absorbing member 76 absorbs the liquid Lw containing water, the water of the resin ink having a low water content in the absorbing member 76 can be increased. In addition, since the non-thickening resin ink in the absorbing member 76 flows out into the liquid Lw containing water, the amount of the resin ink in the absorbing member 76 can be reduced.

The suction portion 85 sucks the resin ink in the first liquid receiving portion 47f via the second discharge flow path 82f and the reaction liquid in the second liquid receiving portion 47s via the second discharge flow path 82s. Actually, the liquid sucked from the inside of the first liquid receiving portion 47f at this time is a resin ink in which a small amount of resin ink is mixed with the liquid Lw containing water. When the liquid Lw containing water that fills the inside of the first liquid receiving portion 47f is discharged from the second discharge port 72a provided at a position not come into contact with the absorbing member 76, the absorbing member 76 is provided at a position overlapping the liquid level of the liquid Lw containing water remaining in the first liquid receiving portion 47f The second discharge port 72a may be provided between the containing surface 76a as the upper surface of the absorbing member 76 and the lower surface 76e in the vertical direction Z. As a result, the height of the liquid level of the liquid Lw containing water is the height of the second discharge port 72a, and the absorbing member 76 can be immersed in the liquid Lw containing water supplied and stored in the first liquid receiving portion 47f to the height of the second discharge port 72a. As a result, even when the water evaporates from the absorbing member 76, the absorbing member 76 absorbs the liquid Lw containing water stored in the first liquid receiving portion 47f, so that the drying of the resin ink in the absorbing member 76 can be suppressed. As time elapses, water evaporates from the resin ink absorbed by the absorbing member 76, and the resin ink absorbed by the absorbing member 76 gradually thickens, so that this operation is performed periodically.

By including the space 78 below the absorbing member 76, the liquid receiving portion 47 can contain the liquid Lw containing water not only in the absorbing member 76 but also in the space below the absorbing member 76. As a result, the absorbing member 76 absorbs a large amount of the liquid Lw containing water, so that the water of the resin ink having a low water content in the absorbing member 76 can be increased.

When the amount of reaction liquid absorbed by the absorbing member 76 is small, for example, when the number of flushing of the reaction liquid is small, the amount of newly supplied reaction liquid is small, and as time elapses, water evaporates from the reaction liquid absorbed by the absorbing member 76, so that the reaction liquid absorbed by the absorbing member 76 gradually solidifies. In such a case, the absorbing member 76 cannot absorb the reaction liquid ejected from the liquid ejecting portion 20 due to clogging, and the absorption of the contained reaction liquid from the opening portion 75 into the absorbing member 76 is hindered. A solidified product of the reaction liquid may be accumulated on the containing surface 76a of the absorbing member 76, and the nozzle surface of the liquid ejecting portion 20 may be contaminated. Since the water of the reaction liquid is likely to be evaporated and solidified, it is desirable that the liquid Lw containing water is periodically supplied to the reaction liquid absorbed by the absorbing member 76 so that the absorbing member 76 is not clogged, and the reaction liquid is redissolved in the liquid Lw containing water.

As illustrated in FIG. 13, when the amount of reaction liquid absorbed by the absorbing member 76 is small, the flow path switching portion 86 switches to a state where the second discharge flow path 82f communicating with the first liquid receiving portion 47f and the second discharge flow path 82s communicating with the second liquid receiving portion 47s communicate with the suction portion 85. As a result, the second discharge flow path 82s communicating with the second liquid receiving portion 47s can be switched to a state of communicating with the suction portion 85.

The liquid receiving device 42 is provided with the liquid supply portion 90 capable of supplying the liquid Lw containing water in the liquid receiving portion 47 into the second liquid receiving portion 47s. More specifically, the switching valve 94 communicates the liquid delivery flow path 93 with the liquid supply flow path 91s, and the delivery portion 95 supplies the liquid Lw containing water in the liquid tank 92 into the first liquid receiving portion 47f As a result, the liquid Lw containing water can be supplied into the second liquid receiving portion 47s.

When the liquid Lw containing water is supplied into the second liquid receiving portion 47s from the liquid supply port 73a, the absorbing member 76 is immersed in the liquid Lw containing water supplied and stored in the second liquid receiving portion 47s. As a result, the reaction liquid in the absorbing member 76 is redissolved and flows out into the liquid Lw containing water, so that the amount of the reaction liquid in the absorbing member 76 can be reduced.

The suction portion 85 sucks the resin ink in the first liquid receiving portion 47f via the second discharge flow path 82f and the reaction liquid in the second liquid receiving portion 47s via the second discharge flow path 82s. The reaction liquid sucked at this time is a reaction liquid in which a small amount of the reaction liquid is mixed with the liquid Lw containing water. When the liquid Lw containing water that fills the inside of the second liquid receiving portion 47s is discharged from the second discharge port 72a provided at a position not come into contact with the absorbing member 76, the absorbing member 76 is provided at a position overlapping the liquid level of the liquid Lw containing water remaining in the second liquid receiving portion 47s. The second discharge port 72a may be provided between the containing surface 76a as the upper surface of the absorbing member 76 and the lower surface 76e in the vertical direction Z. As a result, the height of the liquid level of the liquid Lw containing water is the height of the second discharge port 72a, and the absorbing member 76 can be immersed in the liquid Lw containing water supplied and stored in the second liquid receiving portion 47s to the height of the second discharge port 72a. The liquid Lw containing water stored up to the height of the second discharge port 72a can suppress the subsequent drying of the reaction liquid in the absorbing member 76. As time elapses, water evaporates from the reaction liquid absorbed by the absorbing member 76, and the reaction liquid absorbed by the absorbing member 76 gradually solidifies, so that this operation is performed periodically.

By including the space 78 below the absorbing member 76, the liquid receiving portion 47 can contain the liquid Lw containing water not only in the absorbing member 76 but also in the space below the absorbing member 76. As a result, the reaction liquid absorbed by the absorbing member 76 can be redissolved in the liquid Lw containing a large amount of water stored in the second liquid receiving portion 47s, and a large amount of the reaction liquid can flow out from the absorbing member 76.

The number of flushing from the nozzle 36 that ejects the resin ink and the number of flushing from the nozzle 36 that ejects the reaction liquid may be reduced. That is, the amount of resin ink absorbed by the absorbing member 76 disposed in the opening portion 75 of the first liquid receiving portion 47f and the amount of the reaction liquid absorbed by the absorbing member 76 disposed in the opening portion 75 of the second liquid receiving portion 47s are reduced.

As illustrated in FIG. 13, when the amount of the resin ink absorbed by the absorbing member 76 and the amount of reaction liquid absorbed by the absorbing member 76 are small, the flow path switching portion 86 switches to a state where the second discharge flow path 82f communicating with the first liquid receiving portion 47f and the second discharge flow path 82s communicating with the second liquid receiving portion 47s communicate with the suction portion 85. As a result, one suction portion 85 can switch to a state where the second discharge flow path 82f communicating with the first liquid receiving portion 47f and the second discharge flow path 82s communicating with the second liquid receiving portion 47s communicate with the suction portion 85.

When the liquid Lw containing water is supplied into the first liquid receiving portion 47f from the liquid supply port 73a, the absorbing member 76 is immersed in the liquid Lw containing water supplied and stored in the first liquid receiving portion 47f As a result, since the absorbing member 76 absorbs the liquid Lw containing water, the water of the resin ink having a low water content in the absorbing member 76 can be increased. In addition, since the non-thickening resin ink in the absorbing member 76 flows out into the liquid Lw containing water, the amount of the resin ink in the absorbing member 76 can be reduced.

When the liquid Lw containing water is supplied into the second liquid receiving portion 47s from the liquid supply port 73a, the absorbing member 76 can be immersed in the liquid Lw containing water supplied and stored in the second liquid receiving portion 47s. As a result, the reaction liquid in the absorbing member 76 is redissolved and flows out into the liquid Lw containing water, so that the amount of the reaction liquid in the absorbing member 76 can be reduced.

The suction portion 85 sucks the resin ink in the first liquid receiving portion 47f via the second discharge flow path 82f and the reaction liquid in the second liquid receiving portion 47s via the second discharge flow path 82s. The absorbing member 76 in the first liquid receiving portion 47f is immersed in the liquid Lw containing water stored in the first liquid receiving portion 47f. The absorbing member 76 in the second liquid receiving portion 47s is immersed in the liquid Lw containing water stored in the second liquid receiving portion 47s. As a result, even when the water evaporates from the absorbing member 76, the absorbing member 76 absorbs the liquid Lw containing water stored in the first liquid receiving portion 47f, so that the drying of the resin ink in the absorbing member 76 can be suppressed. In addition, the reaction liquid absorbed by the absorbing member 76 in the second liquid receiving portion 47s can be redissolved in the liquid Lw containing water stored in the second liquid receiving portion 47s and flowed out from the absorbing member 76. The liquid Lw containing water stored up to the height of the second discharge port 72a can suppress the subsequent drying of the reaction liquid in the absorbing member 76.

The effects of the present embodiment will be described.

In the liquid receiving device 42 and the liquid ejecting apparatus 11 according to the present embodiment, the following effects can be obtained.

(1) The first communication portion 71 is provided at a position where the first discharge port 71a is in contact with the absorbing member 76. As a result, the resin ink or the reaction liquid absorbed by the absorbing member 76 can be discharged from the first discharge port 71a. When the amount of the resin ink or the reaction liquid contained by the absorbing member 76 is large, the amount of the resin ink or the reaction liquid absorbed by the absorbing member 76 can be reduced. That is, it is possible to prevent the resin ink or the reaction liquid ejected from the liquid ejecting portion 20 from overflowing from the opening portion 75 of the liquid receiving portion 47.

The second communication portion 72 is provided at a position where the second discharge port 72a does not come into contact with the absorbing member 76. As a result, the resin ink having a low water content in the absorbing member 76 absorbs the water from the liquid Lw containing water stored in the liquid receiving portion 47 or the resin ink. As a result, it is possible to prevent the resin ink absorbed by the absorbing member 76 from drying and thickening in the absorbing member 76. That is, it is possible to prevent the resin ink contained from being hindered from being absorbed into the inside of the absorbing member 76 from the opening portion 75 due to clogging of the absorbing member 76. As a result, it is possible to prevent the solidified product of the resin ink from accumulating on the containing surface 76a of the absorbing member 76 and contaminating the nozzle surface.

In the resin ink, even when the amount of resin ink contained by the liquid receiving device 42 in the absorbing member 76 changes depending on the usage status of the liquid ejecting apparatus 11, it is possible to suppress the failure of the liquid receiving device 42 that occurs when the absorbing member 76 cannot absorb the resin ink ejected from the liquid ejecting portion 20.

(2) The liquid ejected from the liquid ejecting portion 20 is a liquid containing water, and the liquid receiving device 42 is provided with the liquid supply portion 90 capable of supplying the liquid Lw containing water into the liquid receiving portion 47. When the liquid supply portion 90 supplies the liquid Lw containing water into the liquid receiving portion 47, the absorbing member 76 is immersed in the liquid Lw containing water supplied and stored in the liquid receiving portion 47 to absorb the liquid Lw containing water, or absorbs the water evaporating from the stored liquid Lw containing water. Therefore, the water of the resin ink having a low water content in the absorbing member 76 can be increased. In addition, since the non-thickening resin ink in the absorbing member 76 flows out into the liquid Lw containing water, the amount of the resin ink in the absorbing member 76 can be reduced. In the case of a reaction liquid redissolved in water, the reaction liquid absorbed by the absorbing member 76 can be redissolved in the liquid Lw containing water stored in the liquid receiving portion 47 and flowed out from the absorbing member 76. When the reaction liquid absorbed by the absorbing member 76 flows out into the liquid Lw containing water, the absorbing member 76 can be brought closer to the state before the reaction liquid is absorbed. As a result, it is possible to prevent the resin ink or reaction liquid absorbed by the absorbing member 76 from drying and thickening or solidifying in the absorbing member 76. That is, it is possible to prevent the resin ink or the reaction liquid contained from being hindered from being absorbed into the inside of the absorbing member 76 from the opening portion 75 due to clogging of the absorbing member 76. As a result, it is possible to prevent the solidified product of the resin ink or the reaction liquid from accumulating on the containing surface 76a of the absorbing member 76 and contaminating the nozzle surface.

(3) The liquid receiving portion 47 includes the space 78 below the absorbing member 76. As a result, the liquid receiving portion 47 can contain the liquid Lw containing water not only in the absorbing member 76 but also in the space below the absorbing member 76. Therefore, the resin ink or the reaction liquid absorbed by the absorbing member can be continuously humidified with the liquid Lw containing a large amount of water. As a result, it is possible to further prevent the resin ink or reaction liquid absorbed by the absorbing member 76 from drying and thickening or solidifying in the absorbing member 76.

(4) The absorbing member 76 is provided at a position overlapping the liquid level of the liquid Lw containing water remaining in the liquid receiving portion 47 when the liquid Lw containing water filling the inside of the liquid receiving portion 47 is discharged from the second discharge port 72a. The second discharge port 72a may be provided between the containing surface 76a as the upper surface of the absorbing member 76 and the lower surface 76e in the vertical direction Z. After the inside of the liquid receiving portion 47 is filled with the liquid Lw containing water, the liquid Lw containing water in the liquid receiving portion 47 is discharged from the second discharge port 72a. Therefore, the height of the liquid level of the liquid Lw containing water in the liquid receiving portion 47 can be easily set at a position overlapping the absorbing member 76. As a result, even when the water evaporates from the absorbing member 76, the absorbing member 76 absorbs the liquid Lw containing water stored in the first liquid receiving portion 47f from the portion overlapping the liquid Lw containing water stored in the liquid receiving portion 47. Therefore, it is possible to suppress the drying of the resin ink in the absorbing member 76. In the case of a reaction liquid redissolved in water, the reaction liquid absorbed by the absorbing member 76 can be redissolved in the liquid Lw containing water stored in the liquid receiving portion 47 and a large amount of the reaction liquid can be flowed out from the absorbing member 76. When the reaction liquid absorbed by the absorbing member 76 flows out into the liquid Lw containing water, the absorbing member 76 can be brought closer to the state before the reaction liquid is absorbed. In addition, the absorbing member 76 is kept in a moist state by the liquid Lw containing water stored up to the height of the second discharge port 72a. As a result, it is possible to further prevent the resin ink or reaction liquid absorbed by the absorbing member 76 from drying and thickening or solidifying in the absorbing member 76.

(5) The liquid receiving device 42 includes the fence column 74e as a projection portion in which the liquid receiving portion 47 engages with the end portion of the absorbing member 76 around the second discharge port 72a. As a result, it is possible to prevent the absorbing member 76 from coming into contact with the second discharge port 72a and to prevent the second discharge port 72a from being blocked by the absorbing member 76.

(6) The liquid receiving device 42 is provided with the suction portion 85 that sucks the resin ink or the reaction liquid in the liquid receiving portion 47 via the first discharge flow path 81 or the second discharge flow path 82, and the flow path switching portion 86 capable of switching the discharge flow path communicating with the suction portion 85 of the first discharge flow path 81 and the second discharge flow path 82. Therefore, one suction portion 85 can enable the suction of the resin ink or the reaction liquid in the liquid receiving portion 47 via the first discharge flow path 81 and the second discharge flow path 82, respectively.

Therefore, in one suction portion 85, even when the amount of resin ink or reaction liquid contained by the liquid receiving device 42 in the absorbing member 76 in the two liquid receiving portions 47 changes depending on the usage status of the liquid ejecting apparatus 11, it is possible to suppress the failure of the liquid receiving device 42 that occurs when the absorbing member 76 cannot absorb the resin ink or the reaction liquid ejected from the liquid ejecting portion 20.

(7) The flow path switching portion 86 enables one suction portion 85 to suck the resin ink in the first liquid receiving portion 47f via the first discharge flow path 81f and the reaction liquid in the second liquid receiving portion 47s via the first discharge flow path 81s. The one suction portion 85 can enable the suction of the resin ink in the first liquid receiving portion 47f via the second discharge flow path 82f and the reaction liquid in the second liquid receiving portion 47s via the second discharge flow path 82s. That is, one suction portion 85 can enable the same discharge control for the two liquid receiving portions 47.

Therefore, even when the amount of resin ink and reaction liquid contained by the liquid receiving device 42 in the absorbing member 76 in the two liquid receiving portions 47 changes depending on the usage status of the liquid ejecting apparatus 11, it is possible to suppress the failure of the liquid receiving device 42 that occurs when the absorbing member 76 cannot absorb the resin ink and the reaction liquid ejected from the liquid ejecting portion 20.

(8) The first discharge port 71a is provided on one end side of the liquid receiving portion 47 in the longitudinal direction, and the second discharge port 72a is provided on the other end side of the liquid receiving portion 47 in the longitudinal direction. As a result, the first liquid receiving portion 47f and the second liquid receiving portion 47s can be disposed close to each other in the lateral direction, so that the width direction of the liquid receiving device 42 can be reduced. That is, it is possible to prevent the liquid receiving device 42 from being increased.

(9) The liquid receiving device 42 is provided with the first cover 48f configured to cover the opening portion 75 of the first liquid receiving portion 47f, the second cover 48s configured to cover the opening portion 75 of the second liquid receiving portion 47s, and one drive mechanism 30 capable of simultaneously moving the first cover 48f and the second cover 48s. As a result, the first cover 48f for suppressing the drying of the resin ink contained in the first liquid receiving portion 47f and the second cover 48s for suppressing the drying of the reaction liquid contained in the second liquid receiving portion 47s can be driven by one drive mechanism 30. That is, it is possible to prevent the liquid receiving device 42 from being increased.

(10) In the liquid receiving device 42, the first liquid receiving portion 47f and the second liquid receiving portion 47s are elastically deformable, respectively. The liquid receiving device 42 includes the deformed portion 70a that can come into contact with the first cover 48f and the second cover 48s in a state of surrounding the opening portion 75, and the surface of the deformed portion 70a is subjected to the water-repellent treatment. As a result, the deformed portion 70a is elastically deformed, so that the adhesion between the first liquid receiving portion 47f and the first cover 48f and the adhesion between the second liquid receiving portion 47s and the second cover 48s can be improved. When the deformed portion 70a is in close contact with the first cover 48f, the resin ink absorbed in the absorbing member 76 can be prevented from rising on the inner surface of the opening portion 75 due to the capillary force, so that it is possible to prevent the resin ink from dripping on the outer surface of the opening portion 75. In addition, when the deformed portion 70a is in close contact with the second cover 48s, the reaction liquid absorbed in the absorbing member 76 can be prevented from rising on the inner surface of the opening portion 75 due to the capillary force, so that it is possible to prevent the reaction liquid from dripping on the outer surface of the opening portion 75.

### Second Embodiment

Hereinafter, a second embodiment of the liquid ejecting apparatus 11 will be described with reference to the drawings. Since the second embodiment is substantially the same as the first embodiment, duplicate descriptions will be omitted by assigning the same reference numerals to the same configurations.

### About Waste Liquid Collection Portion

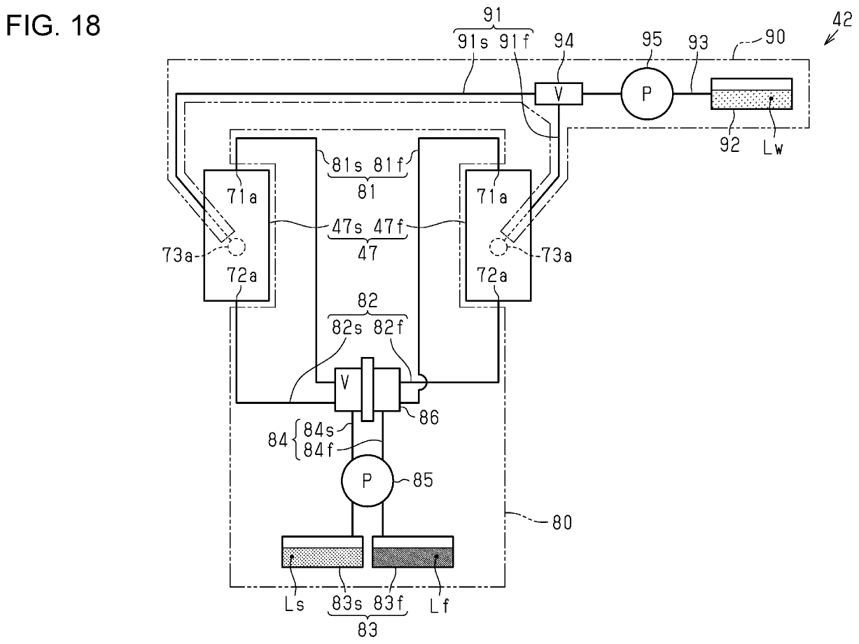

As illustrated in FIG. 18, the flow path switching portion 86 can switch between a state where the first discharge flow path 81f and the second discharge flow path 82s communicate with the suction portion 85 and a state where the first discharge flow path 81s and the second discharge flow path 82f communicate with the suction portion 85.

In a state where the first discharge flow path 81f communicating with the first liquid receiving portion 47f and the second discharge flow path 82s communicating with the second liquid receiving portion 47s communicate with the suction portion 85, the flow path switching portion 86 simultaneously blocks the second coupling flow path and the third coupling flow path. As a result, the first discharge flow path 81f communicates with the collection flow path 84f, and the second discharge flow path 82s communicates with the collection flow path 84s. The suction portion 85 sucks the first liquid Lf from the first discharge flow path 81f to contain the first liquid Lf in the waste liquid tank 83f, and sucks the second liquid Ls from the second discharge flow path 82s to contain the second liquid Ls in the waste liquid tank 83s.

In a state where the second discharge flow path 82f communicating with the first liquid receiving portion 47f and the first discharge flow path 81s communicating with the second liquid receiving portion 47s communicate with the suction portion 85, the flow path switching portion 86 simultaneously blocks the first coupling flow path and the fourth coupling flow path. As a result, the second discharge flow path 82f communicates with the collection flow path 84f, and the first discharge flow path 81s communicates with the collection flow path 84s. The suction portion 85 sucks the first liquid Lf from the second discharge flow path 82f to contain the first liquid Lf in the waste liquid tank 83f, and sucks the second liquid Ls from the first discharge flow path 81s to contain the second liquid Ls in the waste liquid tank 83s.

The operation of the present embodiment will be described.

In the operation of the second embodiment, the description overlapping the operation of the first embodiment will be omitted.

As illustrated in FIG. 18, when the amount of resin ink absorbed by the absorbing member 76 is large, the flow path switching portion 86 switches to a state where the first discharge flow path 81f communicating with the first liquid receiving portion 47f and the second discharge flow path 82s communicating with the second liquid receiving portion 47s communicate with the suction portion 85. As a result, the first discharge flow path 81f communicating with the first liquid receiving portion 47f can be switched to a state of communicating with the suction portion 85.

The suction portion 85 sucks the resin ink in the first liquid receiving portion 47f via the first discharge flow path 81f and the reaction liquid in the second liquid receiving portion 47s via the second discharge flow path 82s. Since the first discharge flow path 81f communicates with the first communication portion 71 and the first communication portion 71 is provided at a position where the first discharge port 71a is in contact with the absorbing member 76, the resin ink absorbed by the absorbing member 76 in the first liquid receiving portion 47f can be discharged from the first discharge port 71a. As a result, the suction portion 85 can suck the resin ink in the first liquid receiving portion 47f via the first discharge flow path 81f The amount of resin ink absorbed by the absorbing member 76 in the first liquid receiving portion 47f can be reduced.

As illustrated in FIG. 18, when the amount of reaction liquid absorbed by the absorbing member 76 is small, the flow path switching portion 86 switches to a state where the first discharge flow path 81f communicating with the first liquid receiving portion 47f and the second discharge flow path 82s communicating with the second liquid receiving portion 47s communicate with the suction portion 85. As a result, the second discharge flow path 82s communicating with the second liquid receiving portion 47s can be switched to a state of communicating with the suction portion 85.

When the liquid Lw containing water is supplied into the second liquid receiving portion 47s from the liquid supply port 73a, the absorbing member 76 is immersed in the liquid Lw containing water supplied and stored in the second liquid receiving portion 47s. As a result, the reaction liquid in the absorbing member 76 is redissolved and flows out into the liquid Lw containing water, so that the amount of the reaction liquid in the absorbing member 76 can be reduced.

The suction portion 85 sucks the resin ink in the first liquid receiving portion 47f via the first discharge flow path 81f and the reaction liquid in the second liquid receiving portion 47s via the second discharge flow path 82s. The reaction liquid sucked at this time is a reaction liquid in which a small amount of the reaction liquid is mixed with the liquid Lw containing water. When the liquid Lw containing water that fills the inside of the second liquid receiving portion 47s is discharged from the second discharge port 72a provided at a position not come into contact with the absorbing member 76, the absorbing member 76 is provided at a position overlapping the liquid level of the liquid Lw containing water remaining in the second liquid receiving portion 47s. The second discharge port 72a may be provided between the containing surface 76a as the upper surface of the absorbing member 76 and the lower surface 76e in the vertical direction Z. As a result, the height of the liquid level of the liquid Lw containing water is the height of the second discharge port 72a, and the absorbing member 76 can be immersed in the liquid Lw containing water supplied and stored in the second liquid receiving portion 47s to the height of the second discharge port 72a. As a result, the liquid Lw containing water stored up to the height of the second discharge port 72a can suppress the subsequent drying of the reaction liquid in the absorbing member 76.

As illustrated in FIG. 18, when the amount of resin ink absorbed by the absorbing member 76 is large and the amount of the reaction liquid absorbed by the absorbing member 76 is small, the flow path switching portion 86 switches to a state where the first discharge flow path 81f communicating with the first liquid receiving portion 47f and the second discharge flow path 82s communicating with the second liquid receiving portion 47s communicate with the suction portion 85. As a result, one suction portion 85 can switch to a state where the first discharge flow path 81f communicating with the first liquid receiving portion 47f and the second discharge flow path 82s communicating with the second liquid receiving portion 47s communicate with the suction portion 85.

When the liquid Lw containing water is supplied into the second liquid receiving portion 47s from the liquid supply port 73a, the absorbing member 76 can be immersed in the liquid Lw containing water supplied and stored in the second liquid receiving portion 47s. As a result, the reaction liquid in the absorbing member 76 is redissolved and flows out into the liquid Lw containing water, so that the amount of the reaction liquid in the absorbing member 76 can be reduced.

The suction portion 85 sucks the resin ink in the first liquid receiving portion 47f via the first discharge flow path 81f and the reaction liquid in the second liquid receiving portion 47s via the second discharge flow path 82s. Since the first discharge flow path 81f communicates with the first communication portion 71 and the first communication portion 71 is provided at a position where the first discharge port 71a is in contact with the absorbing member 76, the resin ink absorbed by the absorbing member 76 in the first liquid receiving portion 47f can be discharged from the first discharge port 71a. As a result, the suction portion 85 can suck the resin ink in the first liquid receiving portion 47f via the first discharge flow path 81f The amount of resin ink absorbed by the absorbing member 76 in the first liquid receiving portion 47f can be reduced. The reaction liquid sucked at this time is a reaction liquid in which a small amount of the reaction liquid is mixed with the liquid Lw containing water. When the liquid Lw containing water that fills the inside of the second liquid receiving portion 47s is discharged from the second discharge port 72a provided at a position not come into contact with the absorbing member 76, the absorbing member 76 is provided at a position overlapping the liquid level of the liquid Lw containing water remaining in the second liquid receiving portion 47s. The second discharge port 72a may be provided between the containing surface 76a as the upper surface of the absorbing member 76 and the lower surface 76e in the vertical direction Z. As a result, the height of the liquid level of the liquid Lw containing water is the height of the second discharge port 72a, and the absorbing member 76 can be immersed in the liquid Lw containing water supplied and stored in the first liquid receiving portion 47f to the height of the second discharge port 72a. As a result, the liquid Lw containing water stored up to the height of the second discharge port 72a can suppress the subsequent drying of the reaction liquid in the absorbing member 76.

As illustrated in FIG. 18, when the amount of reaction liquid absorbed by the absorbing member 76 is large, the flow path switching portion 86 switches to a state where the second discharge flow path 82f communicating with the first liquid receiving portion 47f and the first discharge flow path 81s communicating with the second liquid receiving portion 47s communicate with the suction portion 85. As a result, the first discharge flow path 81s communicating with the second liquid receiving portion 47s can be switched to a state of communicating with the suction portion 85.

The suction portion 85 sucks the resin ink in the first liquid receiving portion 47f via the second discharge flow path 82f and the reaction liquid in the second liquid receiving portion 47s via the first discharge flow path 81s. Since the first discharge flow path 81s communicates with the first communication portion 71 and the first communication portion 71 is provided at a position where the first discharge port 71a is in contact with the absorbing member 76, the reaction liquid absorbed by the absorbing member 76 in the second liquid receiving portion 47s can be discharged from the first discharge port 71a. As a result, the suction portion 85 can suck the reaction liquid in the second liquid receiving portion 47s via the first discharge flow path 81s. The amount of the reaction liquid absorbed by the absorbing member 76 in the second liquid receiving portion 47s can be reduced.

As illustrated in FIG. 18, when the amount of resin ink absorbed by the absorbing member 76 is small, the flow path switching portion 86 switches to a state where the second discharge flow path 82f communicating with the first liquid receiving portion 47f and the first discharge flow path 81s communicating with the second liquid receiving portion 47s communicate with the suction portion 85. As a result, the second discharge flow path 82f communicating with the first liquid receiving portion 47f can be switched to a state of communicating with the suction portion 85.

When the liquid Lw containing water is supplied into the first liquid receiving portion 47f from the liquid supply port 73a, the absorbing member 76 is immersed in the liquid Lw containing water supplied and stored in the first liquid receiving portion 47f As a result, since the absorbing member 76 absorbs the liquid Lw containing water, the water of the resin ink having a low water content in the absorbing member 76 can be increased. In addition, since the non-thickening resin ink in the absorbing member 76 flows out into the liquid Lw containing water, the amount of the resin ink in the absorbing member 76 can be reduced.

The suction portion 85 sucks the resin ink in the first liquid receiving portion 47f via the second discharge flow path 82f and the reaction liquid in the second liquid receiving portion 47s via the first discharge flow path 81s. Actually, the liquid sucked from the inside of the first liquid receiving portion 47f at this time is a resin ink in which a small amount of resin ink is mixed with the liquid Lw containing water. When the liquid Lw containing water that fills the inside of the first liquid receiving portion 47f is discharged from the second discharge port 72a provided at a position not come into contact with the absorbing member 76, the absorbing member 76 is provided at a position overlapping the liquid level of the liquid Lw containing water remaining in the first liquid receiving portion 47f The second discharge port 72a may be provided between the containing surface 76a as the upper surface of the absorbing member 76 and the lower surface 76e in the vertical direction Z. As a result, the height of the liquid level of the liquid Lw containing water is the height of the second discharge port 72a, and the absorbing member 76 can be immersed in the liquid Lw containing water supplied and stored in the first liquid receiving portion 47f to the height of the second discharge port 72a. As a result, even when the water evaporates from the absorbing member 76, the absorbing member 76 absorbs the liquid Lw containing water stored in the first liquid receiving portion 47f, so that the drying of the resin ink in the absorbing member 76 can be suppressed.

As illustrated in FIG. 18, when the amount of the reaction liquid absorbed by the absorbing member 76 is large and the amount of the resin ink absorbed by the absorbing member 76 is small, the flow path switching portion 86 switches to a state where the second discharge flow path 82f communicating with the first liquid receiving portion 47f and the first discharge flow path 81s communicating with the second liquid receiving portion 47s communicate with the suction portion 85. As a result, one suction portion 85 can switch to a state where the second discharge flow path 82f communicating with the first liquid receiving portion 47f and the first discharge flow path 81s communicating with the second liquid receiving portion 47s communicate with the suction portion 85.

When the liquid Lw containing water is supplied into the first liquid receiving portion 47f from the liquid supply port 73a, the absorbing member 76 is immersed in the liquid Lw containing water supplied and stored in the first liquid receiving portion 47f As a result, since the absorbing member 76 absorbs the liquid Lw containing water, the water of the resin ink having a low water content in the absorbing member 76 can be increased. In addition, since the non-thickening resin ink in the absorbing member 76 flows out into the liquid Lw containing water, the amount of the resin ink in the absorbing member 76 can be reduced.

The suction portion 85 sucks the resin ink in the first liquid receiving portion 47f via the second discharge flow path 82f and the reaction liquid in the second liquid receiving portion 47s via the first discharge flow path 81s. Actually, the liquid sucked from the inside of the first liquid receiving portion 47f at this time is a resin ink in which a small amount of resin ink is mixed with the liquid Lw containing water. When the liquid Lw containing water that fills the inside of the first liquid receiving portion 47f is discharged from the second discharge port 72a provided at a position not come into contact with the absorbing member 76, the absorbing member 76 is provided at a position overlapping the liquid level of the liquid Lw containing water remaining in the first liquid receiving portion 47f The second discharge port 72a may be provided between the containing surface 76a as the upper surface of the absorbing member 76 and the lower surface 76e in the vertical direction Z. As a result, the height of the liquid level of the liquid Lw containing water is the height of the second discharge port 72a, and the absorbing member 76 can be immersed in the liquid Lw containing water supplied and stored in the first liquid receiving portion 47f to the height of the second discharge port 72a. As a result, even when the water evaporates from the absorbing member 76, the absorbing member 76 absorbs the liquid Lw containing water stored in the first liquid receiving portion 47f, so that the drying of the resin ink in the absorbing member 76 can be suppressed. In addition, since the first discharge flow path 81s communicates with the first communication portion 71 and the first communication portion 71 is provided at a position where the first discharge port 71a is in contact with the absorbing member 76, the reaction liquid absorbed by the absorbing member 76 in the second liquid receiving portion 47s can be discharged from the first discharge port 71a. As a result, the suction portion 85 can suck the reaction liquid in the second liquid receiving portion 47s via the first discharge flow path 81s. The amount of the reaction liquid absorbed by the absorbing member 76 in the second liquid receiving portion 47s can be reduced.

The effects of the present embodiment will be described.

In the liquid receiving device 42 and the liquid ejecting apparatus 11 according to the present embodiment, the same effects as (1) to (6) and (8) to (10) in the first embodiment can be obtained.

(11) The flow path switching portion 86 enables one suction portion 85 to suck the resin ink in the first liquid receiving portion 47f via the first discharge flow path 81f and the reaction liquid in the second liquid receiving portion 47s via the second discharge flow path 82s. The one suction portion 85 can enable the suction of the resin ink in the first liquid receiving portion 47f via the second discharge flow path 82f and the reaction liquid in the second liquid receiving portion 47s via the first discharge flow path 81s. That is, one suction portion 85 can enable opposite discharge control for the two liquid receiving portions 47.

Therefore, in one suction portion 85, even when the amount of resin ink and reaction liquid contained by the liquid receiving device 42 in the absorbing member 76 in the two liquid receiving portions 47 changes depending on the usage status of the liquid ejecting apparatus 11, it is possible to suppress the failure of the liquid receiving device 42 that occurs when the absorbing member 76 cannot absorb the resin ink and the reaction liquid ejected from the liquid ejecting portion 20.

### Third Embodiment

Hereinafter, a third embodiment of the liquid ejecting apparatus 11 will be described with reference to the drawings. Since the third embodiment is substantially the same as the first embodiment, duplicate descriptions will be omitted by assigning the same reference numerals to the same configurations.

### About Waste Liquid Collection Portion

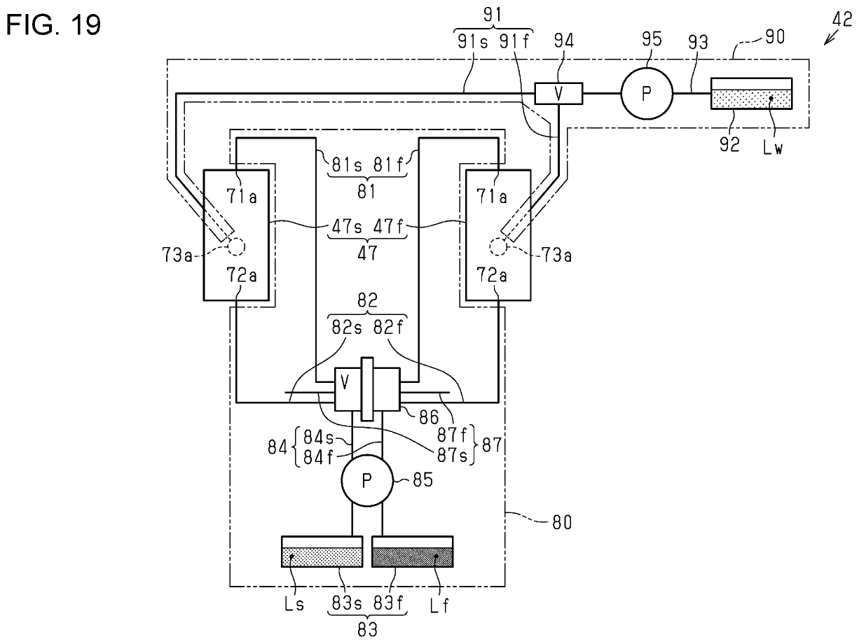

As illustrated in FIG. 19, the waste liquid collection portion 80 is provided with the first discharge flow path 81, the second discharge flow path 82, the waste liquid tank 83, the collection flow path 84, the suction portion 85, the flow path switching portion 86, and an atmosphere open path 87.

The atmosphere open path 87 is a flow path open to the atmosphere. The atmosphere open path 87 is configured to include an atmosphere open path 87f for opening the collection flow path 84f to the atmosphere and an atmosphere open path 87s for opening the collection flow path 84s to the atmosphere.

The flow path switching portion 86 can switch between a state where the first discharge flow path 81f communicates with the suction portion 85, a state where the first discharge flow path 81s communicates with the suction portion 85, a state where the second discharge flow path 82f communicates with the suction portion 85, and a state where the second discharge flow path 82s communicates with the suction portion 85.

In the present embodiment, the flow path switching portion 86 is configured to be able to simultaneously block a plurality of coupling flow paths by driving a cam. The flow path switching portion 86 includes six coupling flow paths. A first coupling flow path couples the first discharge flow path 81f and the collection flow path 84f A second coupling flow path couples the second discharge flow path 82f and the collection flow path 84f A third coupling flow path couples the first discharge flow path 81s and the collection flow path 84s. A fourth coupling flow path couples the second discharge flow path 82s and the collection flow path 84s. A fifth coupling flow path couples the atmosphere open path 87f and the collection flow path 84f A sixth coupling flow path couples the atmosphere open path 87s and the collection flow path 84s.

In a state where the first discharge flow path 81f communicating with the first liquid receiving portion 47f communicates with the suction portion 85, the flow path switching portion 86 simultaneously blocks the second to fifth coupling flow paths. As a result, the first discharge flow path 81f communicates with the collection flow path 84f, and the atmosphere open path 87s communicates with the collection flow path 84s. The suction portion 85 sucks the first liquid Lf from the first discharge flow path 81f to contain the first liquid Lf in the waste liquid tank 83f, and sucks the atmosphere from the atmosphere open path 87s to send out the atmosphere to the waste liquid tank 83s. That is, the suction portion 85 sucks the first liquid Lf from the first discharge flow path 81f to contain the first liquid Lf in the waste liquid tank 83f.

In a state where the second discharge flow path 82f communicating with the first liquid receiving portion 47f communicates with the suction portion 85, the flow path switching portion 86 simultaneously blocks the first coupling flow path and the third to fifth coupling flow paths. As a result, the second discharge flow path 82f communicates with the collection flow path 84f, and the atmosphere open path 87s communicates with the collection flow path 84s. The suction portion 85 sucks the first liquid Lf from the second discharge flow path 82f to contain the first liquid Lf in the waste liquid tank 83f, and sucks the atmosphere from the atmosphere open path 87s to send out the atmosphere to the waste liquid tank 83s. That is, the suction portion 85 sucks the first liquid Lf from the second discharge flow path 82f to contain the first liquid Lf in the waste liquid tank 83f.

In a state where the first discharge flow path 81s communicating with the second liquid receiving portion 47s communicates with the suction portion 85, the flow path switching portion 86 simultaneously blocks the first to second coupling flow paths, the fourth coupling flow path, and the sixth coupling flow path. As a result, the first discharge flow path 81s communicates with the collection flow path 84s, and the atmosphere open path 87s communicates with the collection flow path 84s. The suction portion 85 sucks the second liquid Ls from the first discharge flow path 81s to contain the second liquid Ls in the waste liquid tank 83s, and sucks the atmosphere from the atmosphere open path 87f to send out the atmosphere to the waste liquid tank 83f That is, the suction portion 85 sucks the second liquid Ls from the first discharge flow path 81s to contain the second liquid Ls in the waste liquid tank 83s.

In a state where the second discharge flow path 82s communicating with the second liquid receiving portion 47s communicates with the suction portion 85, the flow path switching portion 86 simultaneously blocks the first to third coupling flow paths and the sixth coupling flow path. As a result, the second discharge flow path 82s communicates with the collection flow path 84s, and the atmosphere open path 87f communicates with the collection flow path 84f The suction portion 85 sucks the second liquid Ls from the second discharge flow path 82s to contain the second liquid Ls in the waste liquid tank 83s, and sucks the atmosphere from the atmosphere open path 87f to send out the atmosphere to the waste liquid tank 83f That is, the suction portion 85 sucks the second liquid Ls from the second discharge flow path 82s to contain the second liquid Ls in the waste liquid tank 83s.

The operation of the present embodiment will be described.

In the operation of the third embodiment, the description overlapping the operation of the first embodiment will be omitted.

As illustrated in FIG. 19, when the amount of resin ink contained by the absorbing member 76 in the first liquid receiving portion 47f is large, the flow path switching portion 86 switches to a state where the first discharge flow path 81f communicating with the first liquid receiving portion 47f communicates with the suction portion 85. The resin ink in the first liquid receiving portion 47f is sucked via the first discharge flow path 81f As a result, the amount of resin ink absorbed by the absorbing member 76 in the first liquid receiving portion 47f can be reduced.

As illustrated in FIG. 19, when the amount of the reaction liquid contained by the absorbing member 76 in the second liquid receiving portion 47s is large, the flow path switching portion 86 switches to a state where the first discharge flow path 81s communicating with the second liquid receiving portion 47s communicates with the suction portion 85. The reaction liquid in the second liquid receiving portion 47s is sucked via the first discharge flow path 81s. As a result, the amount of the reaction liquid absorbed by the absorbing member 76 in the second liquid receiving portion 47s can be reduced.

As illustrated in FIG. 19, when the amount of resin ink contained by the absorbing member 76 in the first liquid receiving portion 47f is small, the flow path switching portion 86 switches to a state where the second discharge flow path 82s communicating with the first liquid receiving portion 47f communicates with the suction portion 85. The liquid Lw containing water is stored in the first liquid receiving portion 47f, and the resin ink in the first liquid receiving portion 47f is sucked via the second discharge flow path 82f The absorbing member 76 in the first liquid receiving portion 47f is immersed in the liquid Lw containing water stored in the first liquid receiving portion 47f As a result, the absorbing member 76 in the first liquid receiving portion 47f absorbs the liquid Lw containing water, so that the water of the resin ink having a low water content in the absorbing member 76 in the first liquid receiving portion 47f can be increased. In addition, since the non-thickening resin ink in the absorbing member 76 flows out into the liquid Lw containing water, the amount of the resin ink in the absorbing member 76 can be reduced. Even when the water evaporates from the absorbing member 76, the absorbing member 76 absorbs the liquid Lw containing water stored in the first liquid receiving portion 47f, so that the drying of the resin ink in the absorbing member 76 can be suppressed.

As illustrated in FIG. 19, when the amount of the reaction liquid contained by the absorbing member 76 in the second liquid receiving portion 47s is small, the flow path switching portion 86 switches to a state where the second discharge flow path 82s communicating with the second liquid receiving portion 47s communicates with the suction portion 85. The liquid Lw containing water is stored in the second liquid receiving portion 47s, and the liquid Lw containing water in the second liquid receiving portion 47s is sucked via the second discharge flow path 82s. The absorbing member 76 in the second liquid receiving portion 47s is immersed in the liquid Lw containing water stored in the second liquid receiving portion 47s. As a result, the reaction liquid absorbed by the absorbing member 76 can be redissolved in the liquid Lw containing water stored in the second liquid receiving portion 47s and flowed out from the absorbing member 76. When the reaction liquid absorbed by the absorbing member 76 flows out into the liquid Lw containing water, the absorbing member 76 can be brought closer to the state before the reaction liquid is absorbed. The liquid Lw containing water stored up to the height of the second discharge port 72a can suppress the subsequent drying of the reaction liquid in the absorbing member 76.

In this manner, in one suction portion 85, even when the amount of resin ink and reaction liquid contained by the liquid receiving device 42 in the absorbing member 76 in the two liquid receiving portions 47 changes depending on the usage status of the liquid ejecting apparatus 11, it is possible to suppress the failure of the liquid receiving device 42 that occurs when the absorbing member 76 cannot absorb the resin ink and the reaction liquid ejected from the liquid ejecting portion 20.

The effects of the present embodiment will be described.

In the liquid receiving device 42 and the liquid ejecting apparatus 11 according to the present embodiment, the same effects as (1) to (6) and (8) to (10) in the first embodiment can be obtained.

(12) The flow path switching portion 86 enables one suction portion 85 to suck the resin ink in the first liquid receiving portion 47f via the first discharge flow path 81f and to suck the resin ink in the first liquid receiving portion 47f via the second discharge flow path 82f, respectively. The one suction portion 85 can further enable the suction of the reaction liquid in the second liquid receiving portion 47s via the first discharge flow path 81s and the suction of the reaction liquid in the second liquid receiving portion 47s via the second discharge flow path 82s, respectively. That is, one suction portion 85 can enable different discharge controls for the two liquid receiving portions 47.

Therefore, in one suction portion 85, even when the amount of resin ink and reaction liquid contained by the liquid receiving device 42 in the absorbing member 76 in the two liquid receiving portions 47 changes depending on the usage status of the liquid ejecting apparatus 11, it is possible to suppress the failure of the liquid receiving device 42 that occurs when the absorbing member 76 cannot absorb the resin ink and the reaction liquid ejected from the liquid ejecting portion 20.

The present embodiment can be modified and performed as follows. The present embodiment and the following modification examples can be performed in combination with each other within a technically consistent range.
Evaporation components other than water may be supplied into the opening portion 75 in the liquid receiving portion 47. In a case in which the evaporation component that is not water evaporates from the liquid ejected from the liquid ejecting portion, and when the thickening or solidification of the liquid progresses due to the evaporation of the evaporation component, the thickening or solidification of the liquid can be suppressed by supplying the evaporation component.
A liquid Lw containing an evaporation component or water may be supplied into the opening portion 75 in the liquid receiving portion 47 by a user or a service man. The user or the service man may move the cover 48 to the open position by operating the operation panel 24, and may supply the liquid Lw containing the evaporation component or water into the opening portion 75 of the liquid receiving portion 47 periodically or, if necessary.
The liquid receiving device 42 may be provided with a third liquid receiving portion 47 capable of containing a third liquid. In the liquid ejecting apparatus 11 in which a plurality of liquids are used, in order to reuse or dispose of the components contained in the plurality of liquids, each of the plurality of liquids may be contained by separate liquid receiving portions 47. For example, in order to reuse or dispose of the components contained in each liquid, the first liquid Lf, the second liquid Ls, and the third liquid may be contained by separate liquid receiving portions 47.
The liquid receiving device 42 may be configured to include a plurality of groups including a combination of a first liquid receiving portion 47 and a second liquid receiving portion 47. In addition, in the above modification example, the liquid receiving device 42 may be configured to include a plurality of groups including a combination of the first liquid receiving portion 47, the second liquid receiving portion 47, and the third liquid receiving portion 47.
The liquid ejecting apparatus 11 may be a liquid ejecting apparatus 11 that ejects a liquid other than ink and a reaction liquid. The state of the liquid ejected as a minute amount of droplets from the liquid ejecting apparatus 11 includes a liquid having a granular, lacrimal, or filamentous tail. The liquid referred to here may be any material that can be ejected from the liquid ejecting apparatus 11. For example, the liquid may be in a state when the substance is in the liquid phase, and include fluids such as highly viscous or low viscous liquids, sol, gel water, other inorganic solvents, organic solvents, solutions, liquid resins, liquid metals, metal melts, and the like. The liquid includes not only a liquid as a state of a substance but also a liquid in which particles of a functional material made of a solid substance such as a pigment or a metal particle are dissolved, dispersed or mixed in a solvent. Typical examples of the liquid include ink, liquid crystal, and the like as described in the above-described embodiment. Here, the ink includes general water-based inks, oil-based inks, and various liquid compositions such as gel inks and hot melt inks. As a specific example of the liquid ejecting apparatus 11, for example, there is a device that ejects a liquid containing a material such as an electrode material or a coloring material used for manufacturing a liquid crystal display, an electroluminescence display, a surface emitting display, a color filter, and the like in a dispersed or dissolved form. The liquid ejecting apparatus 11 may be a device that ejects a bioorganic substance used for manufacturing a biochip, a device that ejects a liquid as a sample used as a precision pipette, a printing device, a micro dispenser, and the like. The liquid ejecting apparatus 11 may be a device that pinpointly ejects lubricating oil to precision machinery such as watches and cameras, a device that ejects a transparent resin liquid such as an ultraviolet curable resin onto a substrate to form a micro hemispherical lens, an optical lens, and the like used for an optical communication element or the like. The liquid ejecting apparatus 11 may be a device that ejects an etching solution such as an acid or an alkali in order to etch a substrate or the like.

Hereinafter, the technical idea and the action and effect grasped from the above-described embodiment and the modification example will be described.

(A) The liquid receiving device includes a liquid receiving portion configured to contain a liquid ejected from a liquid ejecting portion from an opening portion, a first discharge flow path configured to discharge the liquid in the liquid receiving portion, and a second discharge flow path configured to discharge the liquid in the liquid receiving portion, in which the liquid receiving portion includes an absorbing member provided in the liquid receiving portion and configured to absorb the liquid, a first communication portion that has a first discharge port open to an inside of the liquid receiving portion and communicates with the first discharge flow path, and a second communication portion that has a second discharge port open to an inside of the liquid receiving portion and communicates with the second discharge flow path, the first communication portion is provided at a position where the first discharge port is in contact with the absorbing member, and the second communication portion is provided at a position where the second discharge port is not in contact with the absorbing member.

In this configuration, the first communication portion is provided at a position where the first discharge port is in contact with the absorbing member, so that the liquid absorbed by the absorbing member can be discharged from the first discharge port. When the amount of liquid contained by the absorbing member is increased, the amount of liquid absorbed by the absorbing member can be reduced. That is, it is possible to prevent the liquid ejected from the liquid ejecting portion from overflowing from the opening portion of the liquid receiving portion.

In addition, in order to humidify the liquid having a reduced evaporation component in the absorbing member, the liquid can be stored in the liquid receiving portion up to the height of the second discharge port provided at a position not in contact with the absorbing member, and can be continuously humidified by the evaporation component evaporating from the liquid. Alternatively, the absorbing member is immersed in a liquid having a large amount of evaporation component stored in the liquid receiving portion, and the absorbing member absorbs the liquid having a large amount of evaporation component. As a result, when the amount of the liquid contained by the absorbing member is small, it is possible to prevent the liquid absorbed by the absorbing member from drying and thickening in the absorbing member. As a result, it is possible to prevent the liquid contained from being hindered from being absorbed into the absorbing member from the opening portion due to clogging of the absorbing member, and to prevent the solidified product of the liquid from accumulating on the containing surface of the absorbing member and contaminating the nozzle surface.

Even when the amount of liquid contained by the liquid receiving device in the absorbing member changes depending on the usage status of the liquid ejecting apparatus, it is possible to suppress the failure of the liquid receiving device that occurs when the absorbing member cannot absorb the liquid ejected from the liquid ejecting portion.

(B) In the liquid receiving device, the liquid ejected from the liquid ejecting portion is a liquid containing water, and the device may include a liquid supply portion configured to supply the liquid containing water in the liquid receiving portion.

In this configuration, the liquid supply portion supplies the liquid containing water into the liquid receiving portion, so that the liquid absorbed by the absorbing member can be continuously humidified with the water evaporating from the liquid containing water stored in the liquid receiving portion. Alternatively, when the liquid supply portion supplies the liquid containing water into the liquid receiving portion, the absorbing member is immersed in the liquid containing water supplied and stored in the liquid receiving portion to absorb the liquid containing water. Therefore, the water of the liquid having a low water content in the absorbing member can be increased. In addition, since the liquid in the absorbing member flows out into the liquid containing water, the amount of the liquid in the absorbing member can be reduced. When the liquid absorbed by the absorbing member flows out into the liquid containing water, the absorbing member can be brought closer to the state before the liquid is absorbed. As a result, it is possible to prevent the liquid absorbed by the absorbing member from drying and thickening or solidifying in the absorbing member. As a result, it is possible to prevent the liquid contained from being hindered from being absorbed into the absorbing member from the opening portion due to clogging of the absorbing member, and to prevent the solidified product of the liquid from accumulating on the containing surface of the absorbing member and contaminating the nozzle surface.

(C) In the liquid receiving device, the liquid receiving portion may have a space below the absorbing member.

In this configuration, the liquid receiving portion can contain the liquid or the liquid including water not only in the absorbing member but also in the space below the absorbing member. The liquid absorbed by the absorbing member can be continuously humidified with a large amount of water or a large amount of evaporation components that evaporate from a large amount of liquid or a liquid containing water. Therefore, it is possible to further prevent the liquid absorbed by the absorbing member from drying and thickening or solidifying in the absorbing member.

(D) In the liquid receiving device, the absorbing member may be provided at a position overlapping a liquid level of the liquid remaining in the liquid receiving portion when the liquid filling the liquid receiving portion is discharged from the second discharge port.

In this configuration, the liquid or the liquid containing water in the liquid receiving portion is discharged from the second discharge port after the inside of the liquid receiving portion is filled with the liquid or the liquid containing water. Therefore, the height of the liquid level of the liquid or the liquid containing water in the liquid receiving portion can be easily set at a position overlapping the absorbing member. As a result, even when the water or an evaporation component evaporates from the absorbing member, the absorbing member absorbs the liquid or the liquid containing water stored in the liquid receiving portion from the portion overlapping the liquid or the liquid containing water stored in the liquid receiving portion. Therefore, it is possible to suppress the drying of the liquid in the absorbing member. In addition, the liquid absorbed by the absorbing member can flow out from the absorbing member from the portion overlapping the liquid containing water stored in the liquid receiving portion. As a result, it is possible to further prevent the liquid absorbed by the absorbing member from drying and thickening or solidifying in the absorbing member.

(E) In the liquid receiving device, the liquid receiving portion may include a projection portion that engages with an end portion of the absorbing member around the second discharge port.

In this configuration, it is possible to prevent the absorbing member from coming into contact with the second discharge port and to prevent the second discharge port from being blocked by the absorbing member.

(F) In the liquid receiving device, the second discharge port may be provided between an upper surface and a lower surface of the absorbing member in a vertical direction.

In this configuration, the liquid or the liquid containing water in the liquid receiving portion is discharged from the second discharge port after the inside of the liquid receiving portion is filled with the liquid or the liquid containing water. Therefore, the height of the liquid level of the liquid or the liquid containing water in the liquid receiving portion can be easily set at a position overlapping the absorbing member. As a result, even when the water or an evaporation component evaporates from the absorbing member, the absorbing member absorbs the liquid or the liquid containing water stored in the liquid receiving portion from the portion overlapping the liquid or the liquid containing water stored in the liquid receiving portion. Therefore, it is possible to suppress the drying of the liquid in the absorbing member. In addition, the liquid absorbed by the absorbing member can flow out from the absorbing member from the portion overlapping the liquid containing water stored in the liquid receiving portion. As a result, it is possible to further prevent the liquid absorbed by the absorbing member from drying and thickening or solidifying in the absorbing member.

(G) In the liquid receiving device, the device may include a suction portion that sucks the liquid in the liquid receiving portion via the first discharge flow path or the second discharge flow path; and a flow path switching portion configured to switch the discharge flow path communicating with the suction portion, among the first discharge flow path and the second discharge flow path.

In this configuration, one suction portion can enable the suction of the liquid in the liquid receiving portion via each of the first discharge flow path and the second discharge flow path.

Therefore, in one suction portion, even when the amount of liquid contained by the liquid receiving device in the absorbing member in the two liquid receiving portions changes depending on the usage status of the liquid ejecting apparatus, it is possible to suppress the failure of the liquid receiving device that occurs when the absorbing member cannot absorb the liquid ejected from the liquid ejecting portion.

(H) In the liquid receiving device, a first liquid receiving portion configured to receive a first liquid; and a second liquid receiving portion configured to receive a second liquid may be provided, and the flow path switching portion may be configured to be switched between a state where the first discharge flow path communicating with the first liquid receiving portion and the first discharge flow path communicating with the second liquid receiving portion communicate with the suction portion and a state where the second discharge flow path communicating with the first liquid receiving portion and the second discharge flow path communicating with the second liquid receiving portion communicate with the suction portion.

In this configuration, one suction portion can enable both the suction of the liquid in the first liquid receiving portion via the first discharge flow path and the liquid in the second liquid receiving portions via the first discharge flow path and the suction of the liquid in the first liquid receiving portion via the second discharge flow path and the liquid in the second liquid receiving portions via the second discharge flow path. That is, one suction portion can enable the same discharge control for the two liquid receiving portions.

Therefore, in one suction portion, even when the amount of liquid contained by the liquid receiving device in the absorbing member in the two liquid receiving portions changes depending on the usage status of the liquid ejecting apparatus, it is possible to suppress the failure of the liquid receiving device that occurs when the absorbing member cannot absorb the liquid ejected from the liquid ejecting portion.

(I) In the liquid receiving device, a first liquid receiving portion configured to receive a first liquid; and a second liquid receiving portion configured to receive a second liquid may be provided, and the flow path switching portion may be configured to be switched between a state where the first discharge flow path communicating with the first liquid receiving portion and the second discharge flow path communicating with the second liquid receiving portion communicate with the suction portion and a state where the second discharge flow path communicating with the first liquid receiving portion and the first discharge flow path communicating with the second liquid receiving portion communicate with the suction portion.

In this configuration, one suction portion can enable both the suction of the liquid in the first liquid receiving portion via the first discharge flow path and the liquid in the second liquid receiving portions via the second discharge flow path and the suction of the liquid in the first liquid receiving portion via the second discharge flow path and the liquid in the second liquid receiving portions via the first discharge flow path. That is, one suction portion can enable opposite discharge control for the two liquid receiving portions.

Therefore, in one suction portion, even when the amount of liquid contained by the liquid receiving device in the absorbing member in the two liquid receiving portions changes depending on the usage status of the liquid ejecting apparatus, it is possible to suppress the failure of the liquid receiving device that occurs when the absorbing member cannot absorb the liquid ejected from the liquid ejecting portion.

(J) In the liquid receiving device, a first liquid receiving portion configured to receive a first liquid: and a second liquid receiving portion configured to receive a second liquid may be provided, and the flow path switching portion may be configured to be switched between a state where the first discharge flow path communicating with the first liquid receiving portion and the suction portion communicate with each other, a state where the second discharge flow path communicating with the first liquid receiving portion and the suction portion communicate with each other, a state where the first discharge flow path communicating with the second liquid receiving portion and the suction portion communicate with each other, and a state where the second discharge flow path communicating with the second liquid receiving portion and the suction portion communicate with each other.

In this configuration, one suction portion can enable the suction of the liquid in the first liquid receiving portion via the first discharge flow path, the liquid in the first liquid receiving portion via the second discharge flow path, the suction of the liquid in the second liquid receiving portions via the first discharge flow path, and the liquid in the second liquid receiving portions via the second discharge flow path. That is, one suction portion can enable different discharge controls for the two liquid receiving portions.

Therefore, in one suction portion, even when the amount of liquid contained by the liquid receiving device in the absorbing member in the two liquid receiving portions changes depending on the usage status of the liquid ejecting apparatus, it is possible to suppress the failure of the liquid receiving device that occurs when the absorbing member cannot absorb the liquid ejected from the liquid ejecting portion.

(K) In the liquid receiving device, the first discharge port is provided on one end side of the liquid receiving portion in a longitudinal direction, and the second discharge port is provided on the other end side of the liquid receiving portion in the longitudinal direction.

In this configuration, the two liquid receiving portions can be disposed close to each other in the lateral direction, so that the width direction of the liquid receiving device can be reduced. That is, it is possible to prevent the liquid receiving device from being increased.

(L) In the liquid receiving device, the device may include a first cover configured to cover the opening portion of the first liquid receiving portion, a second cover configured to cover the opening portion of the second liquid receiving portion, and one drive mechanism configured to simultaneously move the first cover and the second cover.

In this configuration, two covers for suppressing the drying of the liquid contained in the two liquid receiving portions or the water contained therein can be driven by one drive mechanism. That is, it is possible to prevent the liquid receiving device from being increased.

(M) In the liquid receiving device, each of the first liquid receiving portion and the second liquid receiving portion may include a deformed portion configured to be in contact with the first cover and the second cover and to be elastically deformed in a state of surrounding the opening portion, and a surface of the deformed portion may be subjected to a water-repellent treatment.

In this configuration, the deformed portion is elastically deformed, so that the adhesion between the liquid receiving portion and the cover can be improved, and when the deformed portion is in close contact with the cover, it is possible to prevent the liquid absorbed in the absorbing member from rising on the inner surface of the opening portion due to the capillary force. It is possible to prevent the liquid from dripping on the outer surface of the opening portion.

(N) The liquid ejecting apparatus may include the liquid ejecting portion that ejects a liquid; and the above liquid receiving device.

In this configuration, it is possible to obtain the same effect as that of the liquid receiving device described above.

What is claimed is:

1. A liquid receiving device comprising:
a liquid receiving portion configured to receive a liquid ejected from a liquid ejecting portion via an opening portion;
a first discharge flow path configured to discharge the liquid of the liquid receiving portion; and
a second discharge flow path configured to discharge the liquid of the liquid receiving portion, wherein
the liquid receiving portion includes
an absorbing member provided in the liquid receiving portion and configured to absorb the liquid,
a first communication portion that has a first discharge port open to an inside of the liquid receiving portion and communicates with the first discharge flow path, and
a second communication portion that has a second discharge port open to an inside of in the liquid receiving portion and communicates with the second discharge flow path,
the first communication portion is provided at a position where the first discharge port is in contact with the absorbing member, and
the second communication portion is provided at a position where the second discharge port is not in contact with the absorbing member.

2. The liquid receiving device according to claim 1, wherein
the liquid ejected from the liquid ejecting portion is a liquid containing water, and
the device further comprises
a liquid supply portion configured to supply the liquid containing water in the liquid receiving portion.

3. The liquid receiving device according to claim 1, wherein
the liquid receiving portion has a space below the absorbing member.

4. The liquid receiving device according to claim 1, wherein
the absorbing member is provided at a position overlapping a liquid level of the liquid remaining in the liquid receiving portion when the liquid filling the liquid receiving portion is discharged from the second discharge port.

5. The liquid receiving device according to claim 1, wherein
the liquid receiving portion includes a projection portion that engages with an end portion of the absorbing member around the second discharge port.

6. The liquid receiving device according to claim 1, wherein
the second discharge port is provided between an upper surface and a lower surface of the absorbing member in a vertical direction.

7. The liquid receiving device according to claim 1, further comprising:
a suction portion that sucks the liquid of the liquid receiving portion via the first discharge flow path or the second discharge flow path; and
a flow path switching portion configured to switch a discharge flow path communicating with the suction portion, among the first discharge flow path and the second discharge flow path.

8. The liquid receiving device according to claim 7, wherein
a first liquid receiving portion configured to receive a first liquid, and
a second liquid receiving portion configured to receive a second liquid are provided, and
the flow path switching portion is configured to be switched between
a state where the first discharge flow path communicating with the first liquid receiving portion and the first discharge flow path communicating with the second liquid receiving portion communicate with the suction portion and
a state where the second discharge flow path communicating with the first liquid receiving portion and the second discharge flow path communicating with the second liquid receiving portion communicate with the suction portion.

9. The liquid receiving device according to claim 7, wherein
a first liquid receiving portion configured to receive a first liquid, and
a second liquid receiving portion configured to receive a second liquid are provided, and
the flow path switching portion is configured to be switched between
a state where the first discharge flow path communicating with the first liquid receiving portion and the second discharge flow path communicating with the second liquid receiving portion communicate with the suction portion and
a state where the second discharge flow path communicating with the first liquid receiving portion and the first discharge flow path communicating with the second liquid receiving portion communicate with the suction portion.

10. The liquid receiving device according to claim 7, wherein
a first liquid receiving portion configured to receive a first liquid, and
a second liquid receiving portion configured to receive a second liquid are provided, and
the flow path switching portion is configured to be switched between
a state where the first discharge flow path communicating with the first liquid receiving portion and the suction portion communicate with each other,
a state where the second discharge flow path communicating with the first liquid receiving portion and the suction portion communicate with each other,
a state where the first discharge flow path communicating with the second liquid receiving portion and the suction portion communicate with each other, and
a state where the second discharge flow path communicating with the second liquid receiving portion and the suction portion communicate with each other.

11. The liquid receiving device according to claim 8, wherein
the first discharge port is provided on one end side of the liquid receiving portion in a longitudinal direction, and
the second discharge port is provided on the other end side of the liquid receiving portion in the longitudinal direction.

12. The liquid receiving device according to claim 8, further comprising:
a first cover configured to cover the opening portion of the first liquid receiving portion;
a second cover configured to cover the opening portion of the second liquid receiving portion; and
one drive mechanism configured to simultaneously move the first cover and the second cover.

13. The liquid receiving device according to claim 12, wherein
each of the first liquid receiving portion and the second liquid receiving portion includes
a deformed portion configured to be in contact with the first cover and the second cover and to be elastically deformed in a state of surrounding the opening portion, and
a surface of the deformed portion is subjected to a water-repellent treatment.

14. A liquid ejecting apparatus comprising:
a liquid ejecting portion that ejects a liquid; and
the liquid receiving device according to claim 1.
